(19) United States
(12) Patent Application Publication
(10) Pub. No.: US 2022/0266639 A1
(43) Pub. Date: Aug. 25, 2022

(54) A PUMP

(71) Applicant: Edward John O'CONNOR, London (GB)

(72) Inventor: Edward John O'CONNOR, London (GB)

(21) Appl. No.: 17/620,330

(22) PCT Filed: Jun. 16, 2020
(86) PCT No.: PCT/EP2020/066645

§ 371 Date: Dec. 17, 2021

(30) Foreign Application Priority Data
Jun. 19, 2019 (GB) 1908814.5

(51) Int. Cl. B60C 23/12

(52) U.S. Cl. CPC B60C 23/135; B60C 23/121

(57) ABSTRACT

A pump (1) for housing within a tyre, the pump (1) comprising: a fluid chamber comprising an inlet (4) operatively connectable to the environment and an outlet (6) operatively connectable to a tyre cavity; wherein the fluid chamber is compressible and is configurable to expel air into a tyre cavity via the outlet during compression of the fluid chamber and draw air in from the environment via the inlet during expansion of the fluid chamber; an actuation member configurable to extend through the tread of a tyre for contacting a road surface during use; the actuation member comprising a plate (18) configured to compress the fluid chamber; wherein the actuation member is configured to move between a first position, in which the fluid chamber is expanded, and a second position, in which the fluid chamber is compressed by the plate (18); and the pump (1) is configurable such that, in use, a part of the actuation member is in fluid communication with the tyre cavity and fluid pressure contributes to a first force on the actuation member towards the second position; the pump (1) further comprising: a return (12) arranged to urge the actuation member towards the first position; wherein the fluid chamber and/or return (12) are configured to contribute to a second force acting on the actuation member towards the first position.

### FIELD

Embodiments described herein generally relate to pumps, in particular for use in inflating tyres.

### BACKGROUND

Pumps are used in many applications to mechanically move liquids or gases such as air. Pumps are commonly used to inflate tyres such that the tyre pressure is maintained appropriate for use of the tyres, for example in automobiles and bicycles. Maintaining the correct tyre pressure is important, over or under inflation can result in damage to the tyre tread due to uneven wear, inefficient rotation of the tyre resulting in larger fuel consumption and increased carbon emissions. Furthermore, inaccurate inflation can reduce the control of the tyre and lead to tyre burst which can cause serious accidents.

Typically, pumps will be separate to the tyre and are connected, used, and disconnected, as required. The use of such pumps requires monitoring or the tyre pressure and quick action in order to address any deficiency in order to avoid the issues discussed above.

Advances in technology have led to in car systems which can actively monitor tyre pressure using a gauge located in the tyre. Such a system may alert the driver when the tyre pressure is lower than optimal. However, these systems only alert the driver to the pressure. Action is still required by the user in order to address the issue. As such, delays in pumping the tyre up following notification of an issue can lead to the problems discussed above. It is also possible that the delay between being notified of the issue and fixing the issue can have a negative effect on the tyre, the car and the environment. Furthermore, addressing the low tyre pressure requires a certain amount of time and physical exertion.

It is therefore desirable for a tyre to be self-inflating. Existing examples of self-inflating tyres include systems which use a circular tube that is peristaltically inflated and deflated as the tyre rolls. This system has the problem that if the attached inlet valve malfunctions then the tyre risks over-inflation. A second problem is that it is difficult/impossible for the manufacturer to integrate the valve/regulator system into the tyre wall. As such, this system would typically need to be added afterwards and attached to the wheel valve—this is an expensive and complex procedure.

A further issue is that in such systems the tube ‘pump’ is most commonly situated on the edge of the wheel hub. This means that each time the tyre is removed or fitted, it is at risk of damage or disruption. This risk extends also to severe punctures when the wheel runs flat and the bead is distorted.

A further problem is that the material used in the tube must reliably inflate and deflate many thousands of times without either weakening or losing elasticity—even after the tube remains depressed for long periods when the vehicle is parked. It is difficult to simulate or test such activity in a laboratory which in turn means the technology is experimental even when marketed.

The present invention solves the above mentioned problems by providing a pump which maintains the tyre pressure at an optimum level or within an optimum range. The pump operates automatically, responding to a decrease in pressure and re-inflating the tyre without need for the driver or user to manually check or alter the pressure. Additionally the pump may be fitted to any tyre before or after manufacture in a simple operation and employs tested technology. Furthermore the pump described herein provides a safer tyre pump which is within the tyre and therefore not in danger of damaging the exterior of the tyre or becoming dislodged. This has the added advantage of preserving the tyre tread and reducing the need and frequency of replacing the tyre.

### SUMMARY

According to the disclosure is a pump for housing within a tyre, the pump comprising: a fluid chamber comprising an inlet operatively connectable to the environment and an outlet operatively connectable to a tyre cavity; wherein the fluid chamber is compressible and is configurable to expel air into a tyre cavity via the outlet during compression of the fluid chamber and draw air in from the environment via the inlet during expansion of the fluid chamber; an actuation member configurable to extend through the tread of a tyre for contacting a road surface during use; the actuation member comprising a plate configured to compress the fluid chamber; wherein the actuation member is configured to move between a first position, in which the fluid chamber is expanded, and a second position, in which the fluid chamber is compressed by the plate; the pump is configurable such that, in use, a part of the actuation member is in fluidic communication with the tyre cavity and fluid pressure (e.g. fluid pressure from, or within the tyre cavity) contributes to, or exerts, a first force on the actuation member towards the second position; the pump further comprising: a return arranged to urge the actuation member towards the first position; wherein the fluid chamber and/or return are configured to contribute to, or exert, a second force acting on the actuation member towards the first position.

The return and actuation member may be configured such that, in use, the first force may be greater than or equal to the second force when the actuation member is in the second position and the pressure within the tyre cavity is at a predetermined level.

The pump may be configured such that the force urging the actuation member towards the first position may be greater than or equal to the force urging the actuation member towards the second position when the tyre is at a required, or predetermined, pressure.

The pump may be configured such that the actuation member is movable from the first position towards, or to, the second position under the action of a force imposed on the actuation member as the pump traverses the contact patch of a rolling tyre.

In use, as a tyre in which the pump is arranged rotates, the pump may traverse the contact patch. As the pump traverses the contact patch, a force may be exerted on the actuation member by the road. This force may urge the actuation member from the first position to the second position.

The pump may be configured to such that fluid is expelled from the fluid chamber (e.g. into the tyre cavity) as the actuation member moves from the first to the second position. The actuation member moving from the first to the second position may compress the fluid chamber, expelling fluid therefrom, through the outlet.

The pump may therefore be configured to expel air into the tyre cavity as the pump traverses the contact patch of a tyre.

The return may be configured to move the actuation member from the second position to the first position. The return may be configured to urge the actuation member towards the first position. This may occur after the pump has left the contact patch.

The pump may be configured such that tyre cavity fluid pressure acts on the plate. The tyre cavity fluid pressure may urge the actuation member towards the second position.

The pump may be configured such that fluid pressure within the tyre cavity exerts a first force on the actuation member towards the second position

The return may be configured to urge the actuation member towards the first position against the action of tyre cavity fluid pressure. The fluid chamber may be configured to urge the actuation member towards the first position against the action of tyre cavity fluid pressure.

The pump may be configured such that the force exerted on the actuation member (towards the first position) by the return is equal to the force exerted on the actuation member (towards the second position) by tyre cavity fluid pressure when the pressure in the tyre cavity is at a predetermined—e.g. chosen—level. The pump may also be configured such that the force exerted on the actuation member (towards the first position) by the return is less than the force exerted on the actuation member (towards the second position) by tyre cavity fluid pressure when the pressure in the tyre cavity is at a predetermined—e.g. chosen—level.

The pump may be configured such that the force exerted on the actuation member (towards the first position) by the combined action of the return and the fluid chamber is equal to the force exerted on the actuation member (towards the second position) by tyre cavity fluid pressure when the pressure in the tyre cavity is at a predetermined—e.g. chosen—level. The pump may also be configured such that the force exerted on the actuation member (towards the first position) by the combined action of the return and the fluid chamber is less to the force exerted on the actuation member (towards the second position) by tyre cavity fluid pressure when the pressure in the tyre cavity is at a predetermined—e.g. chosen—level.

The second force may comprise or consist of the return and/or fluid chamber pressure forces.

In use, when the tyre in which the pump is arranged reaches a predetermined pressure, the force exerted on the actuation member by the return (and fluid chamber) may equal the tyre cavity fluid pressure force, when the actuation member is in the second position. As such, the actuation member may stay in the second position. The actuation member may stay in the second position until the tyre cavity fluid pressure drops below the predetermined pressure (i.e. predetermined level).

The actuation member (and/or pump) may be configured or configurable such that when the actuation member is in the first position, the actuation member protrudes from a tread surface of a tyre. The actuation (and/or pump) may be configured or configurable such that when the actuation member is in the second position, the actuation member does not protrude from a tread surface of the tyre (e.g. it is recess with respect to the tread surface).

When in the first position, the actuation member may be engageable with a road surface. When in the second position, the actuation member may be prevented from engaging with a road surface. The actuation member may be configured to move between a position where it can, and cannot, engage a road surface during use.

The predetermined pressure may be equal to the desired tyre pressure. The predetermined pressure may be set at any desirable tyre pressure level. The desired tyre pressure will vary depending on the type of tyre, type of vehicle and type of use for the tyre.

Purely as examples—and it is to be understood that the present disclosure is not be considered limit as such—the predetermined pressure may be within the range of 20-50 psi.

The effect of the above may be that the pump may be configured to move between a first and second position as a tyre rolls along a road when the tyre is underinflated, thus inflating the tyre. The pump may be configured to stay in a second position when the tyre is at or above an optimal, or predetermined pressure. Accordingly, the pump may act to inflate underinflated tyres, but stop inflating the tyre once the tyre reaches a desired pressure.

The pump may comprise a housing.

The housing may be for supporting the fluid chamber, the actuation member and the return. The housing may be attachable to an inside surface of a tyre tread. The housing may be attachable to a tyre tread such that the actuation member can move radially with respect to the tyre axis.

The housing may define a housing cavity. The housing may be configured such that the housing cavity is in fluidic communication with the environment surrounding the housing.

The housing may be configured such that the housing cavity is in fluidic communication with the tyre cavity.

The housing may comprise a valve, nozzle or flow-control device arranged such that fluid can pass into and out of the housing cavity.

The housing may be arranged such that, in use, the valve is in fluid communication with a tyre cavity, such that the fluid pressure in the tyre cavity and the fluid pressure in the housing cavity are equal.

The plate may be housed within the cavity.

The plate may be arranged such that a pressure of fluid within the cavity urges the plate towards the second position.

The return may be arranged adjacent the plate.

The return may be arranged adjacent the fluid chamber.

The return may be configured to be in an expanded configuration when the actuation member is in the first position. The return may be configured to be in a compressed configuration when the actuation member is in the second position.

The return may be configured such that the actuating member stays in the second position when the tyre cavity pressure reaches a predetermined pressure—e.g. a desired pressure.

The return may be configured such that the force acting on the actuating member towards the first position (e.g. by the return and/or the fluid chamber) is equal to the force action on the actuating member towards the second position (e.g. from the tyre cavity fluid pressure), when the actuating member is in the second position.

The return may be a biasing member. The biasing member may be a spring.

The return may comprise a return fluid tank.

The return fluid tank may be toroidal. The return fluid tank may surround the fluid chamber.

The return fluid tank may contain fluid at a second predetermined pressure. The second predetermined pressure may be substantially equal to the first predetermined pressure (i.e. predetermined level). The second predetermined pressure may be higher than that of the first predetermined pressure.

The second predetermined pressure may be selected such that, when the tyre cavity in which the pump is installed is at the desired pressure, the force exerted on the plate by the return (in the compressed configuration) is equal to the force exerted on the plate by the tyre pressure.

The fluid within the return fluid tank may be at, or above, the desired tyre pressure—e.g. the predetermined pressure—when in the compressed configuration. The fluid within the return fluid tank may be at, or above, the desired tyre pressure—e.g. the predetermined pressure—when the actuation member is in the second position.

The return fluid tank may be configured such that the pressure within the return fluid tank when in a compressed configuration, balances the force exerted on the actuation member by the tyre pressure when the tyre is at an optimum pressure.

The return fluid tank may be a closed fluid tank.

The return fluid tank may comprise a one-way valve arranged to permit fluid flow into the return fluid tank, but restrict fluid flow out of the return fluid tank.

The one-way valve may be arranged to permit fluid flow into the return fluid tank from the tyre cavity.

The pump may comprise a base. The base may be connected to, or form part of, the housing. The base may house the fluid inlet and fluid outlet of the fluid chamber.

The fluid chamber may be defined by a surface of the base.

The fluid chamber may further be defined by the plate. The fluid chamber may be defined by a surface adjacent or attached to the plate. The plate may be arranged opposing the base surface.

The fluid chamber may further be defined by an outer wall. The outer wall may be provided by the return. The return may surround the fluid chamber.

The fluid chamber may comprise two compartments or parts. The fluid chamber may be bifurcated. Each part of the fluid chamber may comprise an inlet and an outlet as described herein. The outlet of one part of the fluid chamber may be arranged to expel fluid into the tyre cavity to inflate the tyre. The outlet of one part of the fluid chamber may be arranged to expel fluid through the inlet, or a valve, or a filter. This action may clean the inlet, valve or filter by ejecting dirt or dust.

The pump of claim 1 wherein the plate is adjacent or attached to a surface of the return fluid tank.

The actuation member may comprise a shaft. The shaft may be arranged to extend through a tread of a tyre. The shaft may be connected at a first end to the plate, and at a second end to a head. The shaft may be arrangeable radially within the tyre. The shaft may be arranged to move axially within the pump.

The actuation member may comprise a head, which may be arrangeable to extend from a tread surface of a tyre during use. The head may be for contacting a road surface during use. The head may be a protrusion or projection. That is, the head may be configurable to protrude or project from the tread of a tyre during use.

The plate may be arranged at one end of the actuation member and the head may be attached to the other end of the actuation member.

The actuation member may be arranged to be in fluidic communication with the tyre cavity. The actuation member may be exposed to pressure within the tyre cavity—for example. The actuation member may be arranged such that the pressure of the air within the tyre acts on the actuation member in a first direction—towards the second position.

The head may comprise a contact surface configured to contact a road surface during use. The contact surface may comprise a durable material suited to repeated contact with a road surface. An example of such a material may be a polymeric material which is resistant to abrasion. However, many other materials are also suitable. The contact surface may comprise the same material as a tyre tread, such that the head wears at the same rate as the tyre tread.

The contact surface may comprise a plurality of layers. A first layer may be of a first colour and a second layer may be of a second colour. The first and second colours may be different. The use of a plurality of different layers may allow a user to gauge the level of wear of the head, as the head may change colours as the amount of wear increases.

The head comprises a protective flexible collar. The protective flexible collar may be arranged to surround the head. The protective flexible collar may be arranged to resist the ingress of dirt or moisture into the pump during use. The protective flexible collar may permit movement of the head between the first and second positions.

The collar may comprise a material resistant to penetration or damage by external objections. Examples of suitable materials may include toughened specialist materials such as Kevlar and carbon fibre. Equally a combination or composite of such materials (or other materials) may be suitable.

The pump may comprise a sleeve arranged around the actuation member, wherein the actuation member is arranged to slide with respect to the sleeve. The sleeve may be arranged to be located within a channel through a tyre tread during use.

The fluid chamber outlet may have a one-way valve arranged to permit fluid flow out of the fluid chamber. The one-way valve may be arranged to allow the fluid to enter the tyre cavity.

The fluid chamber inlet may have a one-way valve arranged to permit fluid flow into the fluid chamber. The one-way valve may be arranged to allow fluid from the environment to enter the fluid chamber.

The pump may comprise a stop. The stop may be arranged about, or form part of, the actuation member. The stop may be in the form of a plate. The stop may be arranged to abut the tyre, housing, platform or any other part of the pump and/or tyre in order to limit movement of the actuation member—for example in a direction away from the second position (e.g. towards the first position). The stop may define the first position of the plate.

The pump may comprise a platform arrangeable or arranged between the housing and the inside of the tyre. The platform may be configured to be attached to the tyre. The platform may be flexible. The platform may be configure to provide a flat surface on which the rest of the pump can be located. The platform may comprise one curved, or deformable surface to rest against an inside of the tyre and/or tread, and one flat side on which the pump/housing can be housed/supported.

The pump may comprise a sleeve. The sleeve may be arranged around the actuation member. The actuation member may be free to slide relative to the sleeve. The sleeve may be housed or housable within the channel in the tyre tread. The sleeve may comprise a thread.

The sleeve may be connected to the housing, and may be used to locate the housing within the tyre.

The sleeve may be connected to, extend from, or integral with the platform.

The pump may further comprise a locking mechanism. The locking mechanism may comprise a locking nut. The locking mechanism may further comprise the sleeve. The locking nut may comprise a screw thread. The locking nut may be configured to screwably engage the sleeve to assist in attaching the housing to the tyre. Alternatively, the locking mechanism may be otherwise configured to attach the pump to the tyre.

The pump may comprise a retarder. The retarder may be arranged to resist movement of the actuation member from the second position to the first position. The retarder may be arranged to increase the amount of time it takes for the actuation member to move from the second position to the first position.

The retarder may be configured to ensure that actuation member does not reach the first position before the tyre has completed its revolution. As such, the retarder may be configured to ensure that the pump cycles between a first and second position once every 2, 3, 4, 5 or more than 5 revolutions of the tyre, rather than every single revolution of the tyre.

Further according to the disclosure is a tyre comprising a pump as disclosed anywhere herein.

Where is it disclosed herein that a pump may be suitable for, arrangeable for or otherwise configured for interaction with a tyre, it is to be understood that the disclosure also provides for a tyre comprising a pump arranged as described.

Further according to the disclosure is a tyre comprising a pump, wherein the tyre defines a tyre cavity designed to operate at a predetermined tyre pressure; the pump is arranged inside the tyre and comprises: a fluid chamber comprising an inlet operatively connectable to the environment and an outlet operatively connectable to the tyre cavity; wherein the fluid chamber is compressible and is configured to expel air into the tyre cavity via the outlet during compression of the fluid chamber and draw air in from the environment via the inlet during expansion of the compressible fluid chamber; an actuation member configurable to extend through a tread of the tyre for contacting a road surface during use; the actuation member comprising a plate configured to compress the fluid chamber; wherein the actuation member is configured to move between a first position, in which the fluid chamber is expanded, and a second position, in which the fluid chamber is compressed by the plate; and the pump is configured such that a part of the actuation member is in fluidic communication with the tyre cavity and fluid pressure (e.g. tyre cavity fluid pressure) contributes to, or exerts, a first force on the actuation member towards the second position; and the pump further comprising: a return arranged to urge the actuation member towards the first position; wherein the pump is configured such that the actuation member cycles between the first and second positions as the tyre rolls to inflate the tyre when the tyre is under the predetermined pressure; and the pump is configured such that the actuation member stays in the second position when the tyre is at or above the predetermined pressure.

The plate may be arranged such that, in use, fluid pressure within the tyre cavity exerts a first force on the actuation member towards the second position.

The pump may be installed in a tyre. The pump may be installed in any pneumatic tyre. Specific (non-limiting) examples of such a tyre include a bicycle tyre, a car tyre, a LGV tyre, a HGV tyre or an agricultural vehicle tyre.

The tyre may define a channel through the crown and/or tread of the tyre. The channel may be arranged such that the actuation member can extend through the channel. The actuation member of the pump may extend through the channel such that, in use, the actuation member can contact a road surface.

The actuation member may extend through a channel in the tyre tread and may be free to move axially relative to the channel in the tyre and radially with respect to a tyre axis.

The channel may define a recess in the tread of the tyre, into which an end of the actuation member may extend. The actuation member may comprise a head. The head may be arranged within the tread of the tyre.

The actuation member may protrude from the surface of the tyre tread when the actuation member is in the first position.

When the actuation member is in the first position, the actuation member may be configured to contact a road surface when the actuation member traverses the tyre contact point during rolling of the tyre. Contact with a road surface may urge the actuation member from the first position towards the second position.

Movement of the actuation member from the first position towards the second position may compress the fluid chamber.

The actuation member may be level with, or recessed with respect to, the tyre tread when the actuation member is in the second position.

When the actuation member is in the second position, the actuation member may be configured such that the actuation member is not urged in the first or second direction when the actuation member traverses the contact patch.

The pump may be attached to a tyre by means of an attachment between the pump housing and the tyre.

The attachment may comprise a mechanical attachment, such as a screw connection or locking nuts or mechanical clasps. The attachment may be provided by a sleeve and locking nut.

The attachment may comprise a chemical attachment, such as glue.

The attachment may comprise a combination of mechanical and chemical attachment means.

A tyre according to the disclosure may comprise two or more pumps as described herein. A first pump may be arranged with the fluid chamber inlet operatively connectable to the environment and an outlet operatively connectable to a tyre cavity. The first pump may be arranged to inflate the tyre. A second pump may be arranged with an inlet operatively connectable to the environment and an outlet operatively connectable to the environment—for example via the inlet. The second pump may be arranged to expel air through the inlet, thus cleaning any filters present therein and maintaining efficient operation of the pump.

The pump as described may include a valve attached to the fluid tank to permit and control a flow of air into the tank; This may take the form of inflation of the tank directly or alternatively from fluid within the tyre.

When arranged to allow fluid from the tyre to inflate or augment the pressure within the tank the valve forms an option to overcome a loss of pressure within the tank to ensure it does not decline to an unwanted degree.

This valve may be combined with valves attached or operative to modify or control the pressure within the housing or may operate independently.

This option may function as an alternative to a sealed fluid tank which may lose pressure over time.

Such valve may be arranged so as to allow the tank to be pressurised to a desired degree in relation to the pressure within the tyre;

for example the valve may be arranged to control the passage of fluid from the tyre into the tank to an approximate or defined degree;

again—by way of example only—the valve may ensure the pressure within the tank is lower than the pressure within the tyre by a defined degree;

For example the valve may be arranged so that the tyre may be inflated by the pump to a desired pressure while the tank is inflated from the tyre to a lower pressure.

Such an arrangement would prevent a cycle whereby each increase in pressure within the tyre by way of the operation of the pump increases the pressure within the tank to the same degree thereby maintaining the pump operation beyond what is desirable or intended.

Such a valve is termed within this application and in reference to the figures as a ‘tank valve’.

Further according to the disclosure is a method of managing tyre pressure using a pump as described herein.

Further according to the disclosure is a method for managing pressure within a tyre, the tyre comprising a pump; the pump comprising: a fluid chamber comprising an inlet operatively connectable to the environment and an outlet operatively connectable to the tyre cavity; wherein the fluid chamber is compressible and is configured to expel air into the tyre cavity via the outlet during compression of the fluid chamber and draw air in from the environment via the inlet during expansion of the compressible fluid chamber; an actuation member configurable to extend through a tread of the tyre for contacting a road surface during use; the actuation member comprising a plate configured to compress the fluid chamber; wherein the actuation member is configured to move between a first position, in which the fluid chamber is expanded, and a second position, in which the fluid chamber is compressed by the plate; the pump is configured such that a part of the actuation member is in fluidic communication with the tyre cavity and fluid pressure (e.g. the tyre cavity fluid pressure) contributes to, or exerts, a first force on the actuation member towards the second position; the pump further comprising: a return arranged to urge the actuation member towards the first position; wherein the method comprises: cycling the actuation member between the first and second positions as the tyre rolls to inflate the tyre when the tyre is under a predetermined pressure; and maintaining the actuation member in the second position when the tyre is at or above the predetermined pressure.

The plate may be arranged such that, in use, fluid pressure within the tyre cavity exerts a first force on the actuation member towards the second position

### BRIEF DESCRIPTION OF THE DRAWINGS

FIG. 1 shows a base for use in a pump with a fluid inlet and fluid outlet, in top, side and bottom view.

FIG. 2 shows the base in side transparent view.

FIG. 3 shows a return fluid tank for use in a pump in a top, bottom and side view.

FIG. 4 shows a sectioned view of the return fluid tank in top and side view.

FIG. 5 shows the return fluid tank in an expanded and compressed configuration with an indicative change in interior air pressure.

FIG. 6 shows the base, fluid chamber and return fluid tank in a top, bottom and side view.

FIG. 7 shows the base, fluid chamber and return fluid tank in side transparent view.

FIG. 8 shows the base, fluid chamber and return fluid tank combined in top, bottom and side transparent view, with the fluid chamber highlighted.

FIG. 9 shows the actuating member, base, fluid chamber and return fluid tank in top and side view, with the actuating member in the first position.

FIG. 10 shows the assembly of FIG. 9, with the actuating member in the second position.

FIG. 11 shows the assembly of FIG. 9 as the actuating member moves into the first position.

FIG. 12 shows a housing for a pump.

FIG. 13 is a side view of a pump.

FIG. 14 is a further side view of a pump with the return fluid tank and air chamber shown in section view.

FIG. 15 shows a schematic tyre and tread portion indicating the position of the tread channel.

FIG. 16 shows the pump of FIG. 13 being assembled in a tyre.

FIG. 17 shows the pump of FIG. 13 being assembled in a tyre.

FIG. 18 shows the pump of FIG. 13 being assembled in a tyre.

FIG. 19 shows the pump of FIG. 13 being assembled in a tyre.

FIG. 20 shows the pump head in exploded and assembled views.

FIG. 21 shows the pump of FIG. 13 being assembled in a tyre.

FIG. 22 shows the pump of FIG. 13 in a tyre with the actuating member in the first position.

FIG. 23 shows a schematic view of the pump of FIG. 13 in position in a tyre.

FIG. 24 shows the pump of FIG. 13 contacting a road surface.

FIG. 25 shows a further view of the pump of FIG. 13 in position in a tyre.

FIG. 26 shows a side view of the pump of FIG. 13 in a tyre with the actuating member in the first position.

FIG. 27 shows the pump of FIG. 13 in a tyre with the actuating member in the second position.

FIG. 28 shows a schematic view of twin balanced pumps in position within a tyre.

FIG. 29 shows a return in which a spring is used to bias the actuating member.

FIG. 30A is a further side view of the pump of FIG. 13 in a tyre with the actuating member in the first position.

FIG. 30B is a further side view of the pump of FIG. 13 in a tyre with the actuating member in the second position.

FIG. 31 shows the pump of FIG. 13.

FIG. 32 shows a pump with a one way valve fitted to the return fluid tank.

FIG. 33 shows a pump wherein the return comprises two opposing magnets.

FIG. 34 shows twin pumps where one pump provides inflation and the other provides filter cleaning.

FIG. 34 (a) shows an alternative actuating.

FIG. 34 (b) shows a pump with the actuating member of FIG. 34(a) with arrows indicating a reduced area of downward pressure from air within the tyre.

FIG. 35 schematically shows a further pump according to the disclosure.

FIGS. 36(A) to (C) show components of a head of a pump.

FIG. 37 shows the head of FIG. 36.

FIG. 38(A) shows a tyre tread with a pump removed.

FIG. 38(B) shows a tyre tread with a pump installed.

FIGS. 39(A) to (C) show a micro rim pump.

FIGS. 40(A) and (B) show a pressure reduction valve and a one-way valve.

FIG. 41 shows a pump including a pressure relief valve and a one-way valve and a tank valve.

FIG. 42 schematically shows the pump of FIG. 41 in operation.

FIG. 43 schematically shows the pump of FIG. 41 in operation FIG. 44 schematically shows the pump of FIG. 41 in operation

FIG. 45 schematically shows the pump of FIG. 41 in operation FIG. 46 shows a head according to the disclosure.

FIG. 47 shows a part of a head according to the disclosure.

FIG. 48 shows a collar according to the disclosure FIG. 49 shows a head according to the disclosure.

FIG. 50 shows a head according to the disclosure.

FIG. 51 shows a side view of a pump including the head of FIG. 50 with the combined head holder and double sleeve positioned above the pump.

FIG. 52 is a further side view of the pump of FIG. 51.

FIG. 53 is a further side view of the pump of FIG. 51.

FIG. 54 is a further side view of the pump of FIG. 51.

### DETAILED DESCRIPTION OF THE DRAWINGS

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

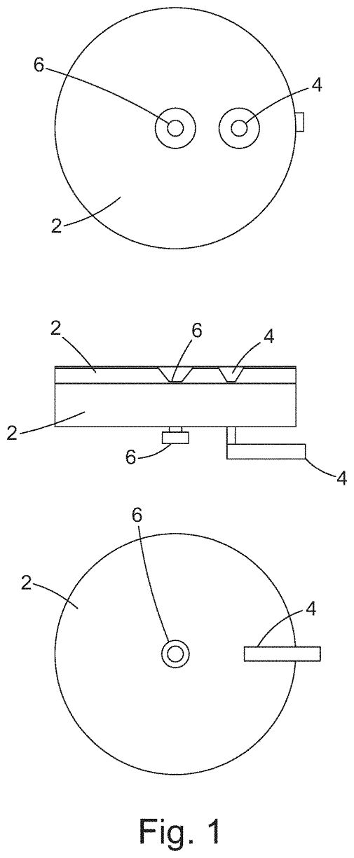

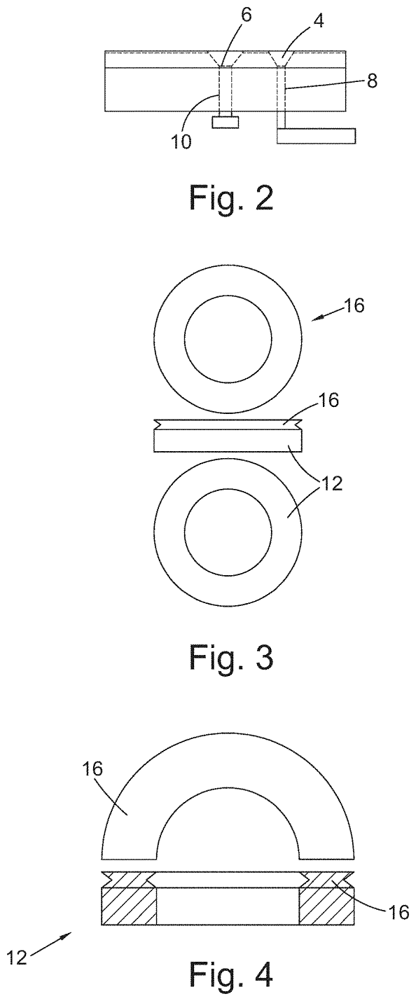

FIGS. 1 and 2 depict a base 2 of a pump. The base 2 is substantially cylindrical.

The base defines an inlet 4 and an outlet 6. The inlet 4 and outlet 6 of the base are for a fluid chamber (not shown).

The base 2 comprises the inlet 4 and outlet 6 on one surface. The base 2 comprises two channels 8, 10, which connect the top surface of the base 2 with the inlet 4 and outlet 6 respectively.

The inlet 4 and outlet 6 comprise valves such that the flow of fluid through each is controlled. The inlet 4 comprises a valve which prevents fluid flowing from the top surface of the base through the channel 8 and out of the pump. This valve therefore only allows fluid to flow into the pump via the inlet 4. In an embodiment not shown the inlet may also comprise a filter to remove contaminants from the fluid.

The outlet 6 comprises a valve which prevents fluid flowing out of the outlet 6 at the top surface of the base 2 and only allows fluid to flow from the top surface to the outlet. The valve therefore only allows fluid to flow out of the pump via the outlet 6.

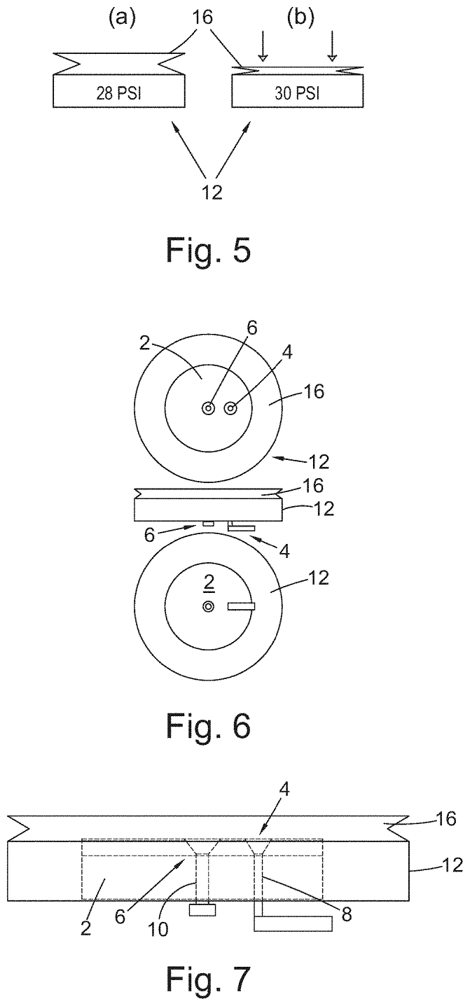

Turning now to FIGS. 3 to 5, a return is illustrated. In this example, the return comprises a return fluid tank 12. The return fluid tank 12 is substantially toroidal in shape. The return fluid tank 12 is configured to surround the base 2.

In other examples, the return may not comprise a fluid tank but may instead comprise a biasing member such as a spring or other resilient member.

In the present example, the return fluid tank 12 contains pressurised fluid, such as air, nitrogen or a combination of fluids. The return fluid tank 12 is set at a predetermined pressure. The return fluid tank 12 is configured to provide a restoring force to allow the pump to cyclically activate during use.

The return fluid tank 12 is compressible, as shown in FIGS. 3-5, such that the volume can be changed, compressing the fluid inside. As the return fluid tank 12 compresses, the pressure in the return fluid tank 12 increases and the restoring force provided by the return fluid tank increases.

The return fluid tank 12 has a compressible section 16 at its upper side. The compressible section 16 may be deformed to decrease the height of the return fluid tank 12, thereby changing the volume inside the return fluid tank, compressing the fluid inside.

The rest of the return fluid tank 12 may be rigid, or more rigid than that of the compressible section 16 such that the outer profile of the return fluid tank 12 is generally maintained.

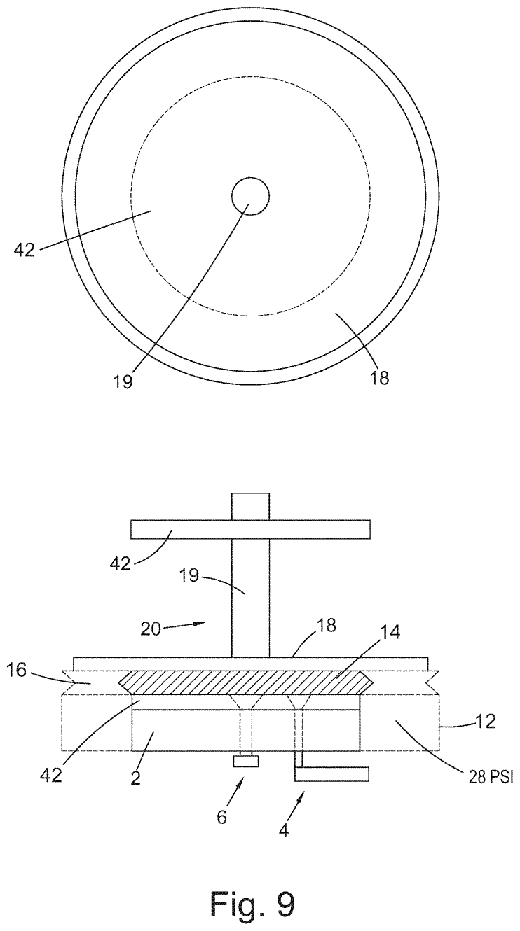

The return fluid tank 12 is configured to urge the actuation member 20 (see FIG. 9) from the second position towards the first position. The return fluid tank 12 is functionally responsible for returning the actuation member 20 from the second to the first position, to allow continued inflation of the tyre 24. The return fluid tank 12 is configured such that the pump only operates when the internal tyre pressure is below a predetermined pressure and stops operating once the predetermined pressure is reached.

In the pump, the compressible section 16 is arranged such that it surrounds the fluid chamber 14 (see FIG. 9), therefore a compression of the compressible section 16 also changes the height of (and thus compresses) the fluid chamber 14.

In other embodiments not shown, the return fluid tank 12 comprises a biasing member instead of, or in addition to, pressurised fluid, which provides the urging force for moving the actuation member 20 towards the first position.

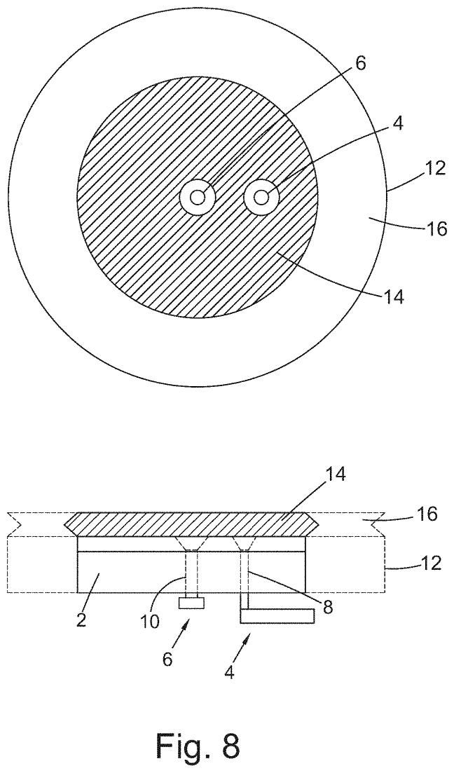

As shown in FIGS. 6 and 7, the base 2 fits within the substantially toroidal-shaped return fluid tank 12. The height of the base 2 is less than the height of the return fluid tank 12. The upper surface of the base 2 is substantially level with the lower edge of the compressible section 16.

A space or cavity is formed above the top surface of the base 2 and enclosed on the sides by the inner wall of the return fluid tank 12. This space created by the return fluid tank 12 and the top surface of the base 2 provides a fluid chamber 14, shown in FIG. 8.

The fluid chamber 14 is a compressible chamber for receiving fluid, such as air. The fluid chamber 14 moves between an expanded and compressed configuration. In this pump, this occurs as the upper portion of the return fluid tank 12 compresses and expands. The fluid chamber 14 is in fluidic communication with the inlet 4 and outlet 6. Fluid moves into and out of the fluid chamber 14 by travelling through the inlet 4 and outlet 6.

The fluid chamber 14 is compressible and is configured to expel air into the tyre cavity. The fluid chamber 14 is configured to expel air into the tyre cavity via the outlet 6 during compression of the fluid chamber. The fluid chamber 14 is configured to draw air in from the environment via the inlet during 4 expansion of the compressible fluid chamber 14.

Turning now to FIG. 9, an actuation member 20 is shown. The actuation member 20 comprises a plate 18 at one end, a stop 42 (which in this specific pump is in the form of a plate) at the other end and a connecting rod 19. The connecting rod 19 runs between and perpendicular to the plate 18 and the stop 42.

The plate 18 is arranged at the top surface of the fluid chamber 14. The plate 18 forms part of the actuation member 20 and is arranged to compress the fluid chamber 14.

The fluid chamber 14 is substantially cylindrical in geometry.

FIG. 9 shows a top and side view of the fluid chamber 14 with an actuation member 20 including the plate 18. The plate 18 is disc shaped. The plate 18 is attached to one end of the actuation member 20.

The plate 18 sits on one surface of the return fluid tank 12 thereby forming, or lying adjacent, a top surface of the fluid chamber 14. The plate 18 is attached to the top surface of the return fluid tank 12 such that they are sealed together. Thus, space created by the base, the return fluid tank 16 and the plate 18 may define the fluid chamber 14.

In this example, the fluid chamber 14 is sealed by the plate 18 and the only way fluid may enter and exit the fluid chamber 14 is via the inlet 4 and outlet 6 (e.g. via channels 8 and 10) defined by the base 2.

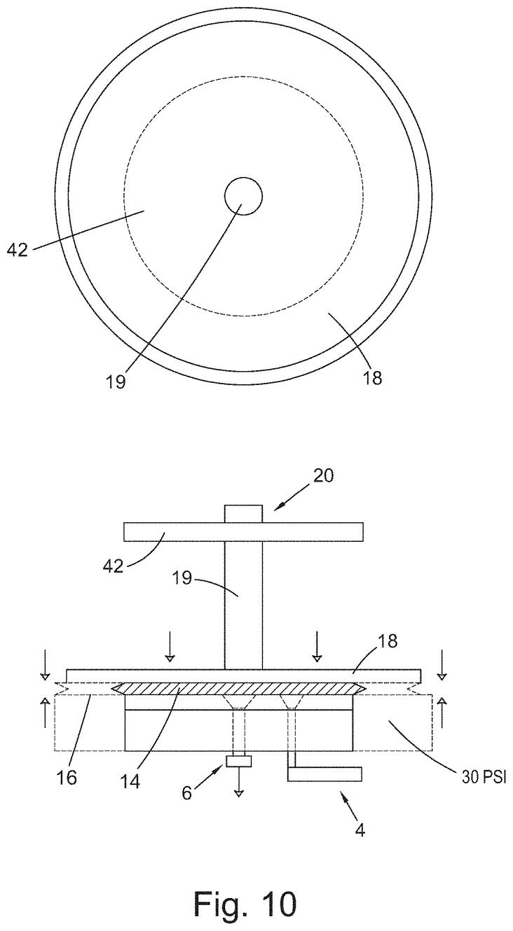

The actuation member 20 is configured to move between a first position (as shown in FIG. 9) and a second position (as shown in FIG. 10). The actuation member 20 moves towards the base 2 to move from the first position to the second position.

As the actuation member 20 (and in particular the plate 18 thereof) moves towards and away from the base 2 and return 12, the compressible section 16 of the return fluid tank 12 compresses and expands and the fluid chamber 14 also compresses and expands. When the actuation member 20 is in the first position, the fluid chamber 14 is expanded. When the actuation member 20 is in the second position, the fluid chamber 14 is compressed.

As the actuation member 20 and, in particular the plate 18, moves towards the base 2 and towards the second position, the fluid chamber 14 is compressed, expelling fluid via the outlet 6. As the actuation member 20 and, in particular the plate 18, moves away from the base 2 and towards the first position, the fluid chamber 14 expands and fluid is drawn in to the fluid chamber 14 via the inlet 4.

As will be described in more detail below, the actuation member 20 may be urged towards the second position—in which the return fluid tank 12 and fluid chamber 14 are in a compressed configuration—as the pump traverses the contact patch of the tyre 24 as the tyre 24 rolls. The actuation member 20 may contact the road surface, thus causing the actuation member 20 to move relative to the tyre 24 and rest of the pump (e.g. the housing, base 2, return fluid tank 12 and fluid chamber 14) to compress the fluid chamber 14 and return fluid tank 12.

The actuation member 20 may be urged from the second position towards the first position—in which the return fluid tank 12 and fluid chamber 14 are in an expanded configuration—by the biasing action of the return fluid tank 12 or a combination of the biasing action of the return fluid tank 12 and the fluid chamber 14. The pressure of fluid within the return fluid tank 12 and fluid chamber 14 may be responsible for exerting a returning force on the actuation member 20.

FIG. 9 illustrates the actuation member 20 in the first position with the fluid chamber 14 and return fluid tank 12 in expanded configurations.

FIG. 10 illustrates the actuation member 20 moving from the first position, in which the fluid chamber 14 is in an expanded state, to the second position, in which the fluid chamber 14 is in a compressed state. In FIG. 10, the pump may be in the process of traversing the contact patch of the tyre 24. The force that the road surface exerts on the actuation member 20 drives the actuation member 20 towards the second position (in which the fluid chamber 14 is compressed) against the action of the fluid pressure in the fluid chamber 14 and the return fluid tank 12. This action will be described in more detail below.

As the fluid chamber 14 is compressed, air inside the fluid chamber 14 is expelled, via the outlet 6, into the tyre 24. Air being expelled from the fluid chamber 14 via the outlet 6 is illustrated by an arrow.

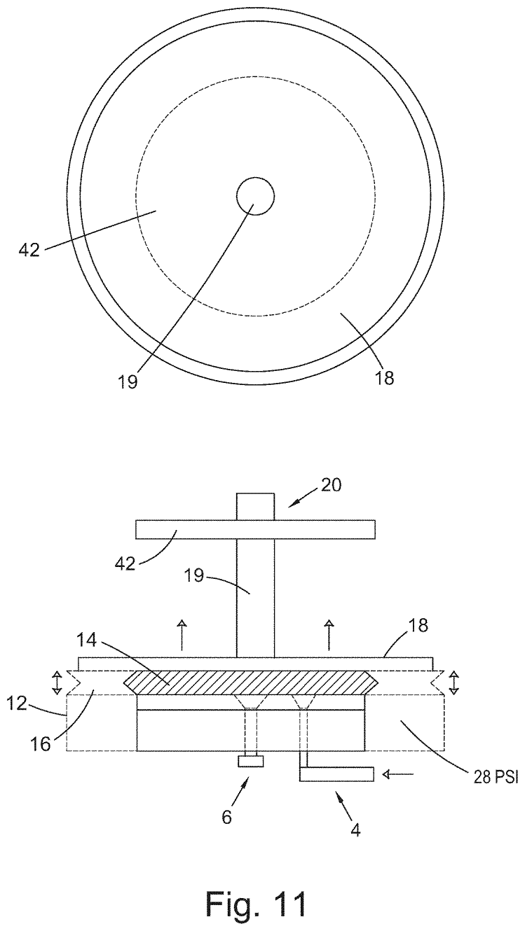

As best seen in FIG. 10 and FIG. 11, the pressure of fluid in the return fluid tank 12 increases as the tank is compressed. The return fluid tank 12 is configured to be at a predetermined pressure when in the compressed and expanded configuration. That is, the pressure inside the return fluid tank 12 is carefully selected. In the present example, the return fluid tank 12 is sealed.

In the example of FIGS. 10 and 11, the return fluid tank 12 is configured to be 30 psi when in the compressed configuration. The pressure in the return fluid tank 12 when in an expanded configuration is 28 psi.

Turning now to FIG. 11, after the force on the actuation member 20 is removed, the compressed return fluid tank 12 urges the actuation member 20 from the second position towards the first position. In doing so, the return fluid tank 12 returns to its expanded configuration and the fluid chamber 14 also goes back to its expanded configuration.

As the fluid chamber 14 expands, fluid—e.g. air—is drawn into the fluid chamber 14 by means of inlet 4, as illustrated by the arrow in FIG. 11. This air is drawn in from the environment, via a conduit and filter (not shown).

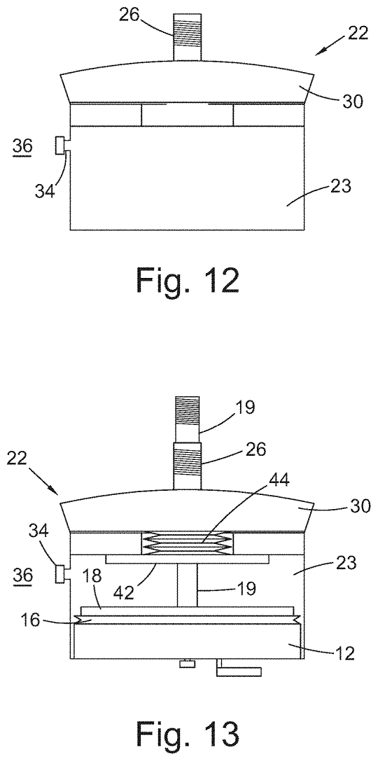

FIG. 12 shows a housing 22 that, in some embodiments, is used to house the pump 1 and secure the pump 1 to a tyre 24. The housing 22 has a threaded sleeve 26 which is used to attach the pump to a tyre 24. The sleeve 26 extends from an end of the housing 22 and is arranged, in use, to extend through a tread 28 of a tyre 24. The housing 22 is substantially cylindrical in geometry.

The sleeve 26 is arranged to receive the rod 19 of the actuation member 20. In use, the actuation member 20 extends through the sleeve and the tyre tread 28. The actuation member 20 is arranged to abut a road surface on the outside of the tyre tread 28 and to engage with components inside a cavity 23 of the housing 22 (described below).

The housing 22 further comprises a platform 30. Other components of the pump and housing 22 may be connected to the platform 30. The sleeve 26 extends from the platform 30 of the housing 22.

The platform 30 may be arranged to locate the pump on an inside surface of the tyre 24. The platform 30 may act as a base or foundation for the pump. One surface of the platform 30 (e.g. that which has the sleeve 26) has a curved outer surface 32. This curved outer surface is configured to fit against the inner curvature of a tyre 24. The platform 30 may be flexible or deformable such that it can accommodate deformation of the tyre 24 (e.g. the tyre tread 28 as the pump traverses the tyre contact patch)

The housing 22 defines a cavity 23

The housing 22 has a port 34. The port 34 comprises a flow-control device to allow fluid to flow into, and out of, the cavity 23. The port 34 may comprise a valve. The port 34 is configured such that the inside of the housing 22 is in fluid communication with the tyre cavity 36.

The port 34 of this example allows the free flow of fluid between the tyre cavity 36 the pump housing 22. In particular, the cavity 23 defined by the housing 22, adjacent the plate 18 (i.e. in which the plate 18 moves), is in fluidic communication with the tyre cavity. As such, during use, the cavity 23 is at the same pressure as the tyre cavity pressure. The side of the plate 18 exposed to tyre cavity pressure opposes that against which the force of the return fluid tank 12 acts. Thus, the fluid pressure inside the housing 22 opposes that of the return fluid tank 12. The actuation member therefore has the tyre cavity pressure acting on it in one direction, and the return fluid tank 12 force (and fluid chamber 14 force) acting on it in an opposing direction.

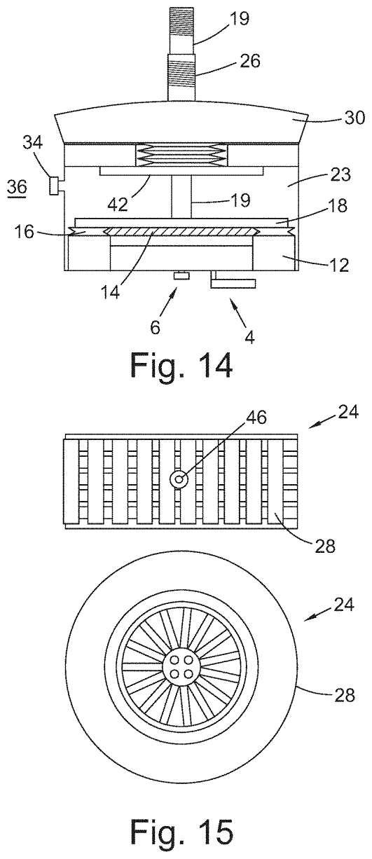

Turning now to FIGS. 13 and 14, the previously-described components of the pump can be seen arranged within the housing 22. The base 2 and return fluid chamber 12 can be seen on a lower (as shown in FIG. 13) surface of the housing 22—that opposing the platform 30. The actuation member 20 is arranged with the plate 18 adjacent the return fluid tank 12 and fluid chamber 14 (as described above). The actuation member 20 extends away from the fluid chamber 14, towards the platform 30.

The stop 42 of the actuation member is attached to the actuation member 20 (or rather the rod 19 thereof) within the housing 22 and is adjacent the platform 30, or an extension thereof. The stop 42 acts to limit the range of movement of the actuation member 20. In this example, the stop 42 acts to limit the movement of the actuation member 20 away from the second position. The stop 42 defines the first position. It also acts to assist with sealing of the pump 1.

The stop 42 is next to a compressible tube 44. The compressible tube 44 comprises concertinaed material arranged to allow compression and expansion. The tube 44 is arranged to surround the actuation member 20 (or rather the rod 19 thereof) and is arranged between the platform 30 and stop 42. The compressible tube 44 assists in sealing the pump arrangement and preventing the ingress of dirt or moisture into the pump into the housing 22 from the outside.

The rod 19, or an extension of the rod 19, extends through the compressible tube 44 and through the platform 30 and sleeve 26. The rod 19 protrudes from the projecting end of the sleeve 26. The end of the rod 19 which protrudes from the sleeve has a screw thread.

The plate 18 of the actuation member 20 is acted upon by tyre cavity pressure on one side (its upper side as shown in FIG. 13). The tyre cavity pressure acts to urge the plate 18 towards the second position, in which the fluid chamber 14 is compressed. The plate 18 is acted upon by the fluid chamber 14 and return fluid tank 12 on its other side (its lower side as shown in FIG. 13). The fluid chamber 14 and return fluid tank 12 urge the plate 18 towards the first position, in which the fluid chamber 14 is expanded.

As the tyre 24 rolls and the pump 1 rotates within the tyre, the pump, and actuation member 20 passes through the contact patch of the tyre. When the tyre 24 is underinflated, the force exerted on the actuation member 20 by the return fluid tank 12 and the fluid chamber 14 is greater than that of the tyre cavity pressure acting on the other side of the plate 18. As such, the actuation member 20 is urged to the first position in the absence of any external influence. In this position, part of the actuation member 20 is positioned such that it contacts the road as the pump traverses the tyre contact patch (as described below).

When the pump traverses the contact patch of the tyre 24, the actuation member 20 is moved from the first position to the second position through interaction with the road surface. This causes the fluid chamber 14 to be compressed, expelling air into the tyre cavity 36.

As the pump leaves the contact patch of the tyre, the road contact force is removed from the actuation member 20. As such, the forces acting on the plate 18 (and hence actuation member 20) are again dominated by the pressure forces—e.g. the tyre cavity pressure force, acting in a direction towards the second position, and the force of the fluid chamber 14 and return fluid tank 12 acting in a direction towards the first position.

If the combination of the return fluid tank 12 and fluid chamber 14 forces is greater than that of the tyre cavity pressure, the actuation member 20 will move from the second position towards the first position. The actuation member 20 may then be back in a position where it can contact the road surface upon a further rotation of the tyre, completing the cycle and allowing a further pumping action to be undertaken. The actuation member 20 can therefore cycle between the first and second positions as the tyre rotates, repeatedly expelling air into the tyre to increase the pressure.

The movement of the actuation member from the second to the first positions may be slowed such that the pump only triggers/cycles once every 2, 3, 4, 5 or more than 5 rotations.

The pump may be configured such that, when the tyre cavity pressure is at a predetermined (e.g. optimal) level, the force exerted on the actuation member 20 by the return fluid tank 12 and fluid chamber 14 is (less than or) equal to that of the tyre cavity pressure force. When this is the case, the actuation member 20 is not urged from the second to the first position after traversing the tyre contact patch. As such, the actuation member 20 is maintained in the second position during subsequent rotations of the tyre. When the actuation member 20 is in the second position, the actuation member 20 does not protrude from the tread surface of the tyre. As such, maintaining the actuation member 20 in the second position stops the inflation process.

FIG. 15 shows a tyre 24 suitable for use with the disclosed pump. The tyre 24 comprises a channel 46. The channel 46 comprises a hole through the tyre tread 28, communicating between the tyre cavity and the outside of the tread. The channel 46 is arranged such that the sleeve 26 (and thus actuation member rod 19) can extend through the channel 46 from the inside of the tyre cavity to the outside of the tread 28.

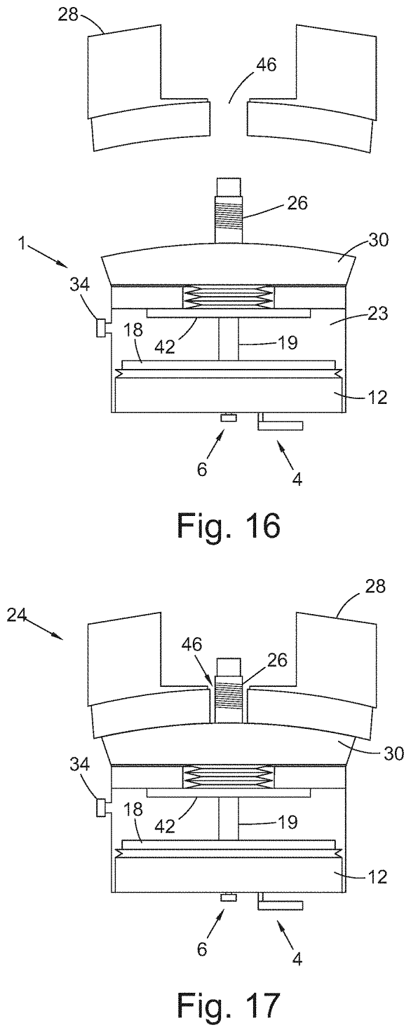

FIGS. 16 to 19 illustrate the attachment of the pump 1 to the tyre tread 28. The tyre tread 28 has a channel 46 suitable for attaching the pump 1. The sleeve 26 on the housing platform 30 is inserted through the channel 46 such that the main body of the pump (including the housing 22) is located on the inside of the tyre 24. The curved surface of the platform 30 is located adjacent the curved inside surface of the tyre 24.

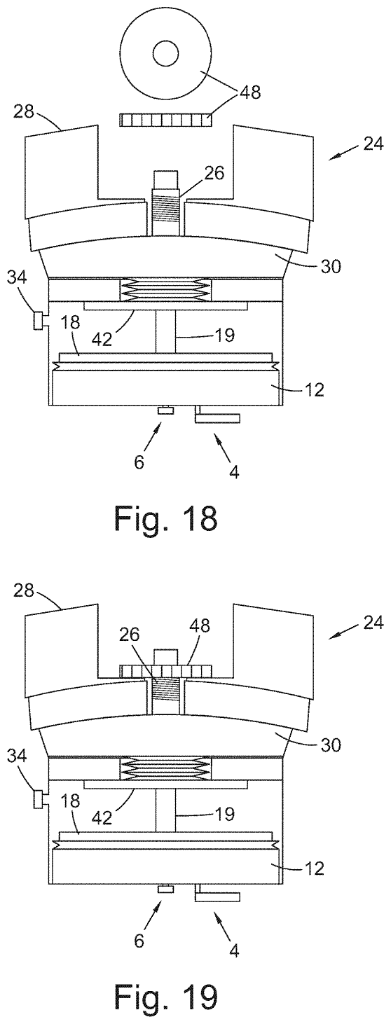

The pump is affixed to the tyre 24 using a locking nut 48 as shown in FIG. 18. FIG. 18 shows a disc shaped nut 48 which is screwed onto the threaded sleeve 26 to secure the housing 22 to the tyre tread 28, also shown in FIG. 19. The attachment between the housing 22 and the tyre 24 is configured to provide a seal and prevent fluid leakage and the ingress of dirt and moisture.

The actuation member 20 extends through the housing 22 and platform 30 and protrudes from the outer surface of the locking nut 48, as shown in FIG. 19.

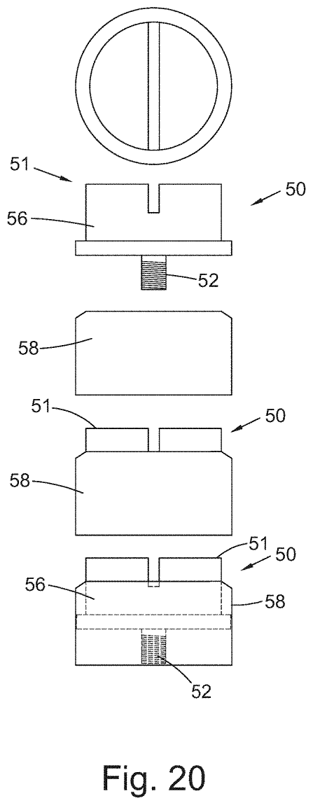

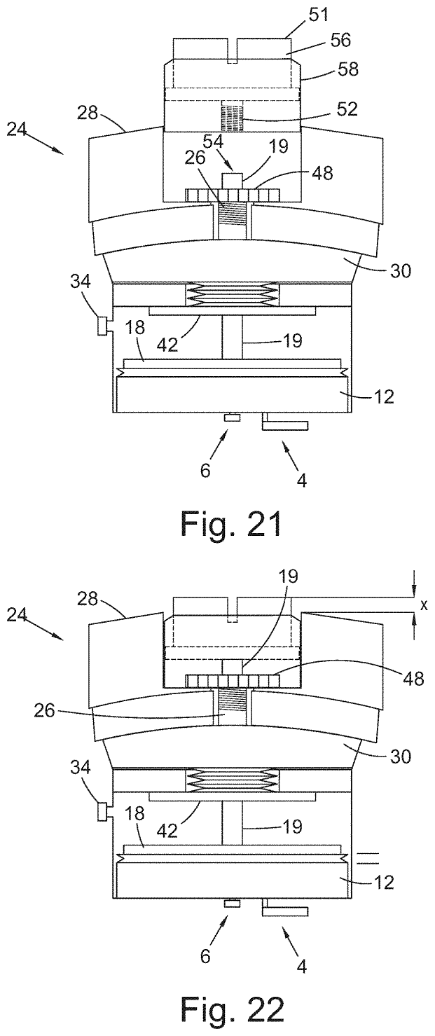

The pump comprises a head 50. The head may form part of the actuation member 20. The head 50 is configured for engaging the road surface. The head 50 is assembled and attached to the pump as shown in FIGS. 20 and 21.

Turning to FIG. 20, the head 50 comprises a substantially cylindrical body 56. The cylindrical body 56 provides a contact surface 51 for engaging a road surface during use. The contact surface 51 may comprise a grip or tread. The head 50, cylindrical body 56, or contact surface 51 may comprise a hard wearing rubber material, such as that used to manufacture tyres. This is only an example of a suitable material and other materials may be equally suitable.

The head 50 attaches to one end of the actuation member 20 (or the rod 19 thereof) by means of a screw thread 52. The screw thread 52 protrudes from the opposite side of the head 50 to the contact surface 51. The screw thread 52 is configured to be screwed into a threaded hole 54 in the shaft of the actuation member 20 (see FIG. 21).

The head 50 further comprises a flexible collar 58. The collar 58 is configured to surround the head 50. The collar 58 is intended to protect the body 56 from damage and to resist the ingress of dirt and/or moisture from the road surface. The collar 58 is configured to be flexible such that it can deform during operation of the pump.

The depth of the head 50 is approximately the same as that of the tyre tread depth.

As shown in FIG. 21, the head 50 is connected to the pump once the pump has been installed in a tyre 24. The head 50 is screwably engaged with the actuation member 20 by means of an internal thread in the end of the rod 19.

FIG. 22 shows the pump installed in a tyre 24. The actuation member 20 is in the first position and the contact surface 51 of the head 50 is protruding from the tyre tread 28 by a distance x. The actuation member 20 is therefore configured to engage a road surface 60 when the tyre 24 is in use. The pump is in this configuration when the tyre 24 is underinflated and hence the tyre pressure force acting on the plate 28 (towards the second position) is smaller than the restoring force of the return fluid tank 12 and fluid chamber 14 (acting towards the first position) such that the actuating member 20 is urged towards the first position.

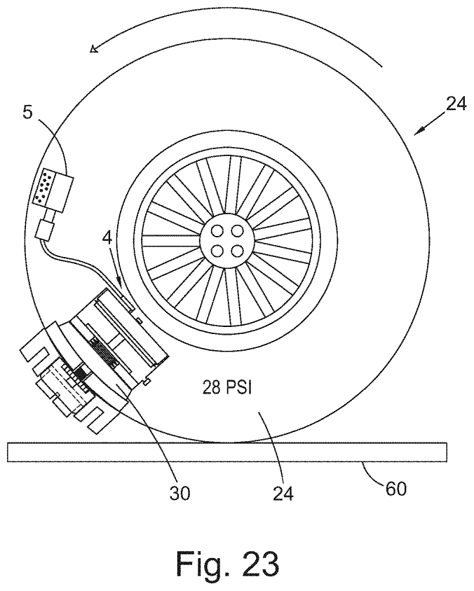

FIG. 23 shows the pump of FIG. 22 in a tyre 24 which is rotating. In FIG. 23, the pump is yet to engage the road surface 60.

FIG. 23 also shows the inlet 4 connected to the environment via an air filter and valve arrangement 5. The air filter and valve arrangement 5 is configured to regulate and clear the air which is drawn into the fluid chamber 14 from the environment.

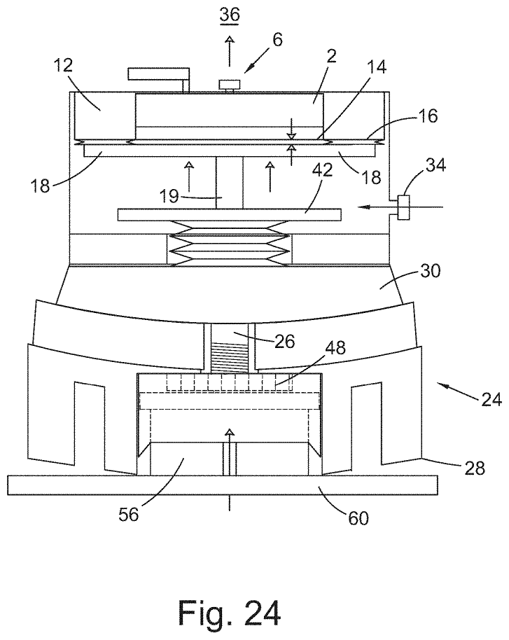

FIG. 24 shows the pump of FIG. 22 as it engages the road surface 60. In FIG. 24, the area of the tread 28 in which the pump is installed is traversing the tyre contact patch. As the pump traverses the contact patch the head 50 of the actuation member 20 engages the road surface and, through this interaction, is urged towards the centre of the tyre 24. This urges the actuation member 20 from the first position towards the second position, as shown in FIG. 24.

As the actuation member 20 moves to the second position, the return fluid tank 12 and the fluid chamber 14 are compressed and air is expelled from the fluid chamber 14 into the tyre cavity 36, pumping up the tyre 24. Simultaneously, air may enter the housing cavity 23 via the port 34.

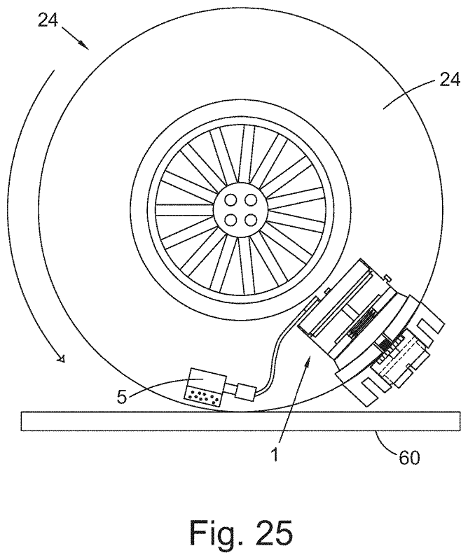

FIG. 25 illustrates the pump of FIG. 22 once the pump has traversed and left the tyre contact patch.

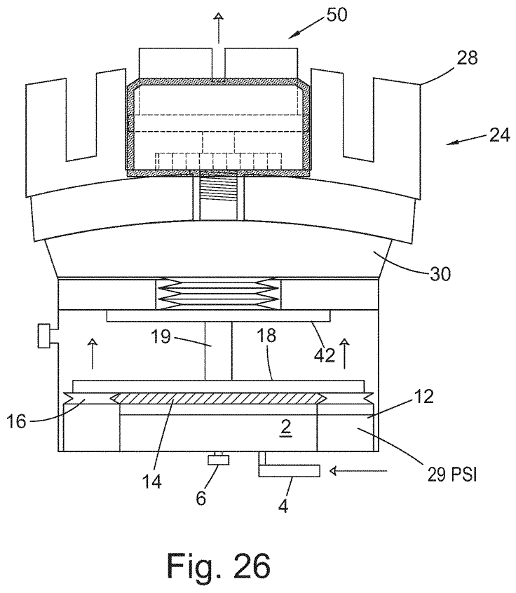

FIG. 26 shows the pump 1 once it has left the contact patch. In FIG. 26, the tyre pressure is less than a desired pressure and, as such, the force exerted on the actuation member 20 by the return fluid tank 12 and fluid chamber 14 exceeds that of the tyre cavity pressure force and the actuation member 20 is urged away from the second position towards the first position. This causes the head 50 to again protrude from the tyre tread surface and the fluid chamber 14 and return fluid tank 12 to expand. Air is drawn into the fluid chamber through inlet 4.

If the tyre cavity is at the desired pressure, the tyre cavity pressure force is equal to, or larger than, the restoring force provided by the return fluid tank 12 (and fluid chamber 14). In this case, after the actuation member 20 has been moved to the second position, it is held there by the tyre cavity pressure force. The actuation member 20 does not move back to the first position and, as such, does not act to inflate the tyre further.

Once the pressure in the tyre cavity reduces below the desired level, the force exerted on the actuation member 20 by the return fluid tank 12 and the fluid chamber 14 is larger than the tyre cavity pressure force and the actuation member 20 is moved to the first position ready to engage the road surface and activate the pump.

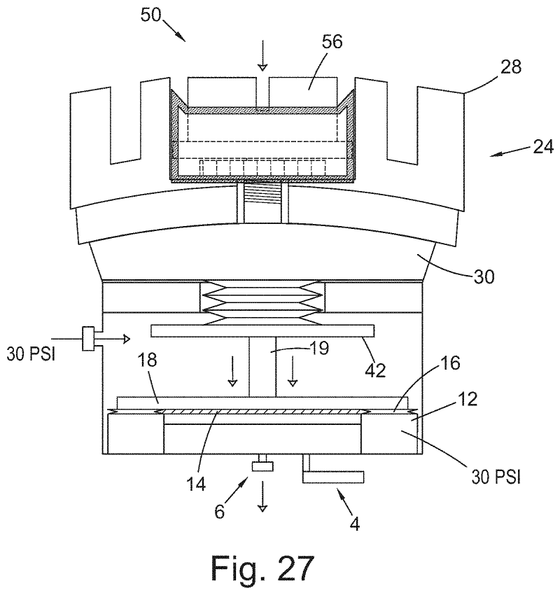

FIG. 27 shows the movement of the actuation member 20 from the first to the second position, as would happen when the actuation member 20 comes into contact with a road surface. When the tyre cavity pressure is at the desired level, the pump is maintained in this configuration.

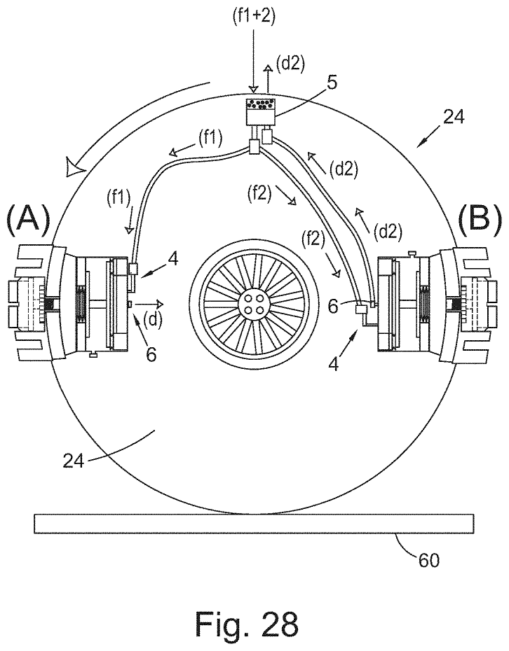

FIG. 28 shows an arrangement in which two pumps 1 are in a single tyre 24. A first pump (A) is arranged as described previously, to draw air in from the environment through the inlet 4 and via the air filter and valve arrangement 5; and expel air into the tyre cavity via the outlet 6 to pump the tyre up. The second pump (B) is arranged to draw air in from the environment via the inlet 4 and air filter and valve arrangement 5. However, the second pump is also arranged to also expel air from the outlet 6 to the environment via the air filter and valve arrangement 5. This pump therefore acts to expel air through the air filter and valve arrangement 5, which can act to remove dirt and debris from the air filter and valve arrangement 5 to clean the air filter and valve arrangement 5.

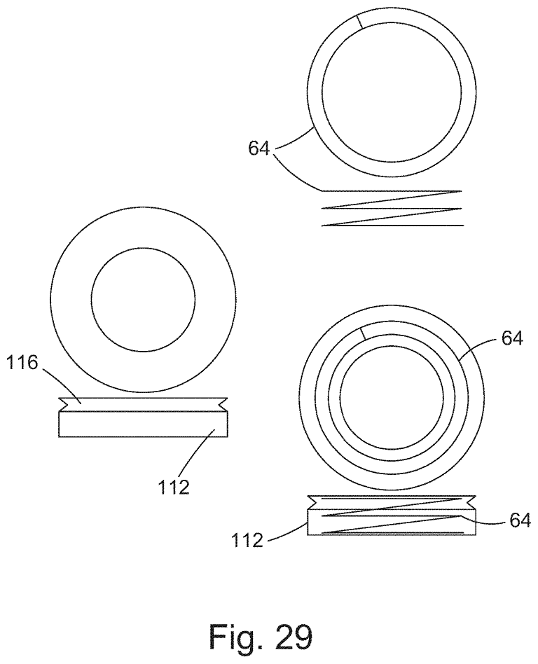

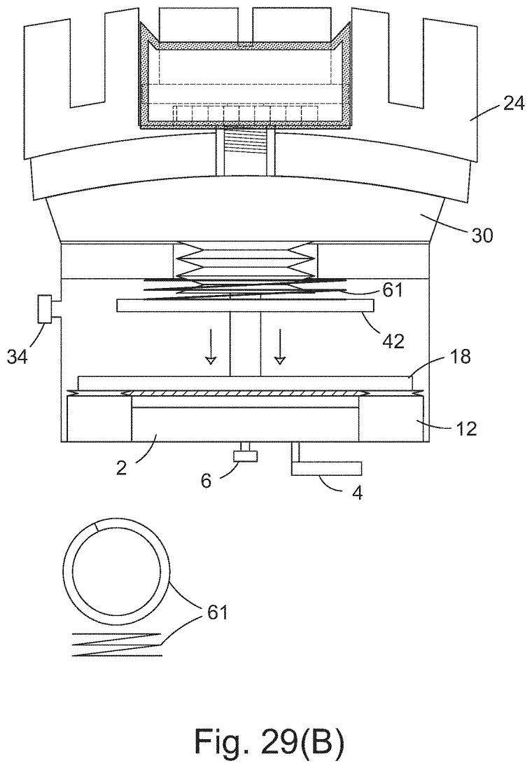

FIG. 29 depicts an alternative example of a return 112. This return 112 comprises a mechanical biasing member in the form of a spring 64 located inside the return 112. This spring 64 may be in addition to, or instead of, pressurised fluid. This return 112 still includes a compressible section 116 in order to allow compression of the return 112 as before. The spring 64 may be arranged to provide the returning force on the actuation member 20 in place of the closed fluid tank.

Further the spring may function as a failsafe such that in the event the return fluid tank were to fail or be ruptured or to otherwise malfunction and the pressure within the tank and the tyre were to fully equalise so as to be undifferentiated by a change of pressure within the tyre then the spring would place the pump in a neutral mode via the pressure of the spring to depress the plate and maintain the actuating member in the second position.

In an embodiment not shown the return fluid tank 12 could be entirely replaced by a biasing member 66 which has a predetermined stiffness. The biasing member 66 could form the return. The biasing member 66 could be contained within a housing.

FIG. 29(B) illustrates a further pump according to the disclosure. The majority of the features of the pump of FIG. 29(B) are equivalent to those of the previously described pumps. The pump of FIG. 29(B) further includes a biasing means in the form of a spring 61. The spring 61 is located between the stop 42 and the platform 30 and is arranged to bias the actuation member 20 towards the second position.

The spring 61 of FIG. 29(B) acts to supplement the force provide by the tyre cavity pressure. Accordingly, this can allow a return with a higher restoring force to be used, or allow a lower desired tyre pressure to be set for the same return restoring force.

The spring assists in urging the actuation member 20 towards the second position. The use of an additional spring which assists in urging the actuation member 20 towards the second position may make it easier to calibrate the force of the return and create the desired balance of forces when the tyre cavity pressure is at the predetermined level.

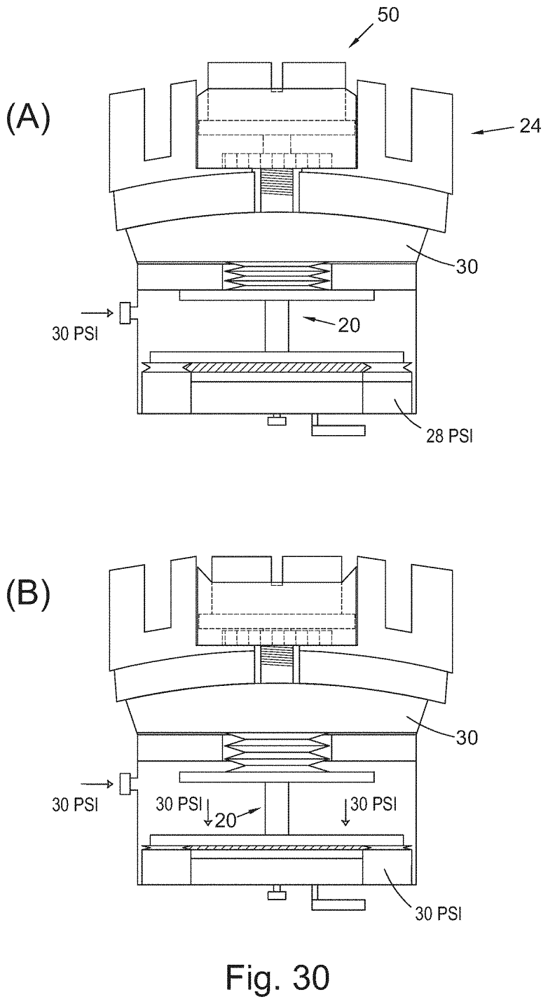

FIGS. 30(A) and 30(B) further illustrate operation of the pump.

The following summary of the operation of the pump will be provided with reference to FIGS. 23 to 28 and 30. The pressure inside the tyre cavity 36 is less that the desired pressure. The pressure inside the return fluid tank 12 is set to provide a force (less than or) equal to the tyre cavity pressure force when the tyre cavity pressure is at a desired level. As the tyre pressure is less than the desired level, the force provided by the return fluid tank 12 (and fluid chamber 14) is greater than that provided by the pressure inside the housing 22 (which is at the tyre cavity pressure). Due to the pressure difference, the return fluid tank 12 expands pushing the plate 18 and actuation member 20 away from the base 2. The expansion of the return fluid tank 12 increases the volume of the fluid chamber 14 and hence fluid is taken into the fluid chamber 14 through the inlet 4 from the atmosphere (or from the atmosphere and through the filter 62 as shown). As a result of expansion of the return fluid tank 12, the actuation member 20 moves radially with respect to the tyre 24 and outwards through the tyre tread 28. The head 50 is forced to protrude relative to the outer surface of the tyre tread 28.

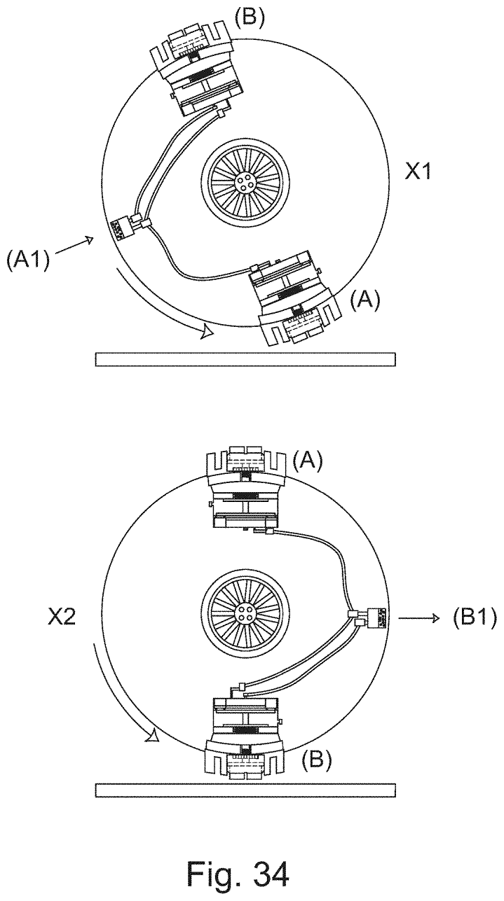

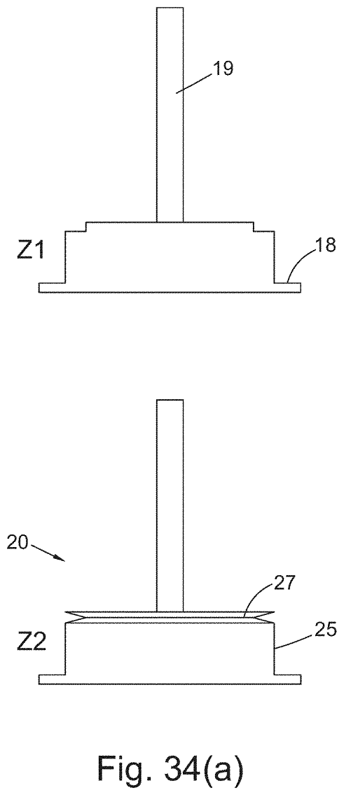

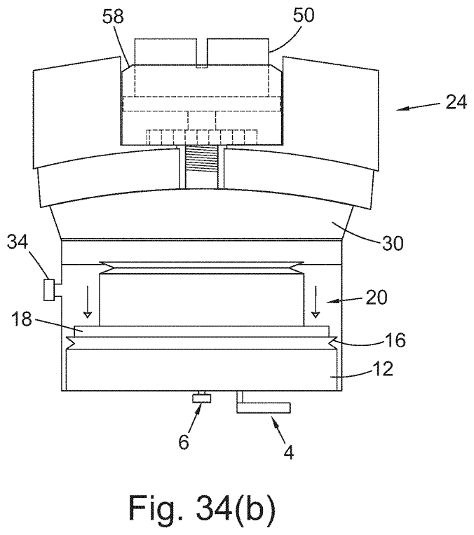

The operation of the pump is illustrated in the figures but it should be noted the relationship between the surface area of the plate and the surface area of the fluid tank is not necessarily to scale; an alternative relationship which is differently balanced is illustrated in FIG. 34b; this balance represents a closer relationship in surface areas as it relates to the respective forces acting to move the plate so as to activate or deactivate the pump.

It should be further noted that in practice this relationship may require calibration to reflect the respective pressures from inside the tyre via the housing acting upon the plate and pressure within the fluid tank acting via contact with the plate such that the operation of the pump accords with the maintenance of a desired pressure within the tyre. The present disclosure and invention provides for such a calibration. This relationship may differ according to the tyre to which the pump is fitted depending upon the pressure within the tyre; such differences may require greater pressure within the fluid tank or alteration in the active area of the plate and/or fluid tank section which connects with the plate or a combination thereof.

In use, the tyre 24 containing the pump 1 in the configuration described rotates over surface 60, shown in FIG. 24. Upon connection with the surface 60, the head 50 is forced radially inwards relative to the tyre 24. This action results in the actuation member 20 and plate 18 compressing the return fluid tank 12 and the fluid chamber 14. The fluid in the fluid chamber 14 is expelled in to the tyre cavity 26 through the outlet 6, increasing the tyre pressure.

As the tyre 24 continues to rotate the head 50 and the tyre 24 are no longer in contact, as shown in FIG. 25. The compressed fluid in the return fluid tank 12 forces the return fluid tank 12 to expand again via the compressible section 16. This action expands the fluid chamber 14 and again fluid from the atmosphere (through filter 62) is drawn into the fluid chamber 14 through the inlet 4, as shown in FIG. 26. This action also forces the head 50 to protrude again and upon rotation of the tyre 24 against a surface 60 the fluid in the fluid chamber 14 is again expelled into the tyre cavity 36, increasing the pressure in the tyre cavity 36, as shown already in FIG. 24.

As long as the force caused by the pressure in the tyre cavity 36 is less than the return force induced by pressure in the return fluid tank 12 (and fluid chamber 14), the return fluid tank 12 will continue to inflate the fluid chamber 14 whilst simultaneously forcing the head 50 to protrude relative to the tyre tread 28, thereby creating a pumping effect. Once the fluid inside the tyre cavity 36 has increased to the desired level, the return fluid tank 12 will not expand once the pump 1 leaves the contact patch and hence no fluid will be drawn into the fluid chamber 14 and the head 50 will not actuated by the actuation member 20.

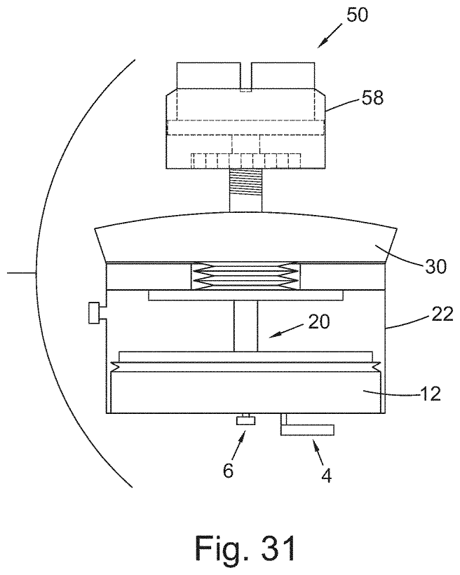

FIG. 31 illustrates an assembled pump.

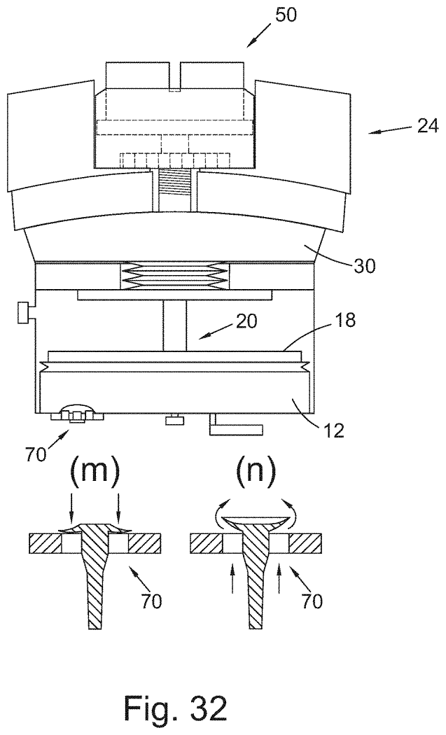

FIG. 32 illustrates a one-way valve 70 which may be located in the return fluid tank 12. The one-way valve 70 may be arranged to allow fluid into the return fluid tank 12, but not out. The one-way valve 70 may allow fluid from the tyre cavity to enter the return fluid tank 12 when the tyre cavity pressure is above that of the return fluid tank 12. Use of this valve may ensure that the return fluid tank 12 pressure is never lower than the tyre cavity pressure. The one-way valve 70 may ensure that the return fluid tank 12 is set to the same pressure as the tyre when the tyre is inflated. This valve 70 may allow a user to inflate the return fluid tank 12 to a pressure equal to the desired tyre pressure by inflating the tyre using conventional means.

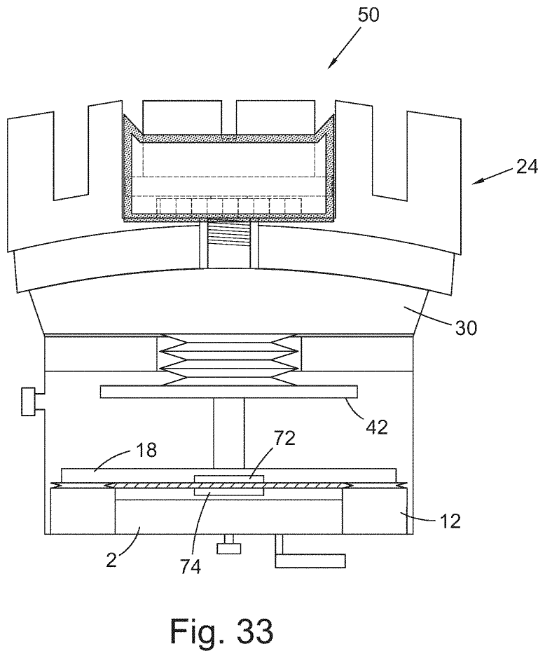

FIG. 33 illustrates an embodiment which employs a pair of magnets 72 and 74—one on each of the plate 18 and the base/fluid chamber 14 or return 12. The magnets 72, 74 may form part of the return. The magnets 72, 74 may be of the same pole and, as such, may repel each other. As such, the magnets 72, 74 may bias the actuation member 20 from the second position towards the first position. Alternatively, the magnets 72, 74 may attract each other and may be used to help calibrate the pump 1 in the same way as the spring in FIG. 29(B)

FIG. 34 depicts that one or more additional pumps 1 may be positioned within the tyre. This configuration may operate as described above, with one pump arranged to inflate the tyre and the other arranged to clean a filter in an inlet. This configuration also helps in balancing the weight of the tyre. Similarly, the positioning of the filter 62 can be chosen to have this effect, as shown in FIGS. 26 and 28.

FIGS. 34(a) and (b) shown an alternative actuation member in an isolated and assembled arrangement respectively. The geometry of the actuation member of FIGS. 34(a) and 34(b) is configured to alter the area over which the tyre cavity fluid pressure acts. To do this, the actuation member 20 comprises a body portion 25 with a concertinaed section 27, arranged to connect the plate 18 to the platform and prevent fluid pressure from acting on the plate 18 in this area.

This may assist in calibrating the force required of the return (e.g. the pressure required in the return fluid tank 12). If the area over which the tyre cavity pressure acts is the same as that of the return fluid tank 12, the return fluid tank 12 can be set at the same pressure as the desired tyre pressure. In some embodiments, the pump may be configured such that the tyre cavity fluid pressure acts over an area of the actuation member 20 (i.e. plate 18) equivalent to that on which the return fluid tank 12 acts.

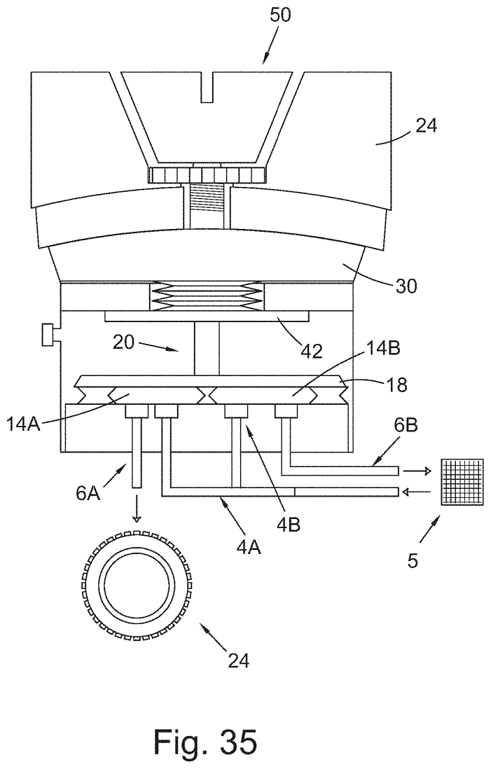

FIG. 35 illustrates an example with a bifurcated fluid chamber. In the example of FIG. 35, the operation of the device is as described above. However, the fluid chamber is separated into two parts, with an inlet and outlet for each part. Thus the pump comprises a first inlet 4A and a first outlet 6A associated with one part of the fluid chamber 14A; and a second inlet 4B and second outlet 6B associated with a second part of the fluid chamber 14B.

The first and second inlets 4A, 4B are both connected to an air filter and valve arrangement 5, through which air is drawn in from the environment. The first outlet 6A is connected to the tyre cavity, as in a standard arrangement, to pump air into the tyre. The second outlet 6B, however, is connected to the air filter and valve arrangement 5, to expel air through the air filter and valve arrangement 5 to eject dirt and debris to clean it. As such, one part of the fluid chamber 14 is used to expel fluid into the tyre cavity to inflate the tyre. The other part is used to expel fluid through an air filter (e.g. the inlet air filter) to clean the filter.

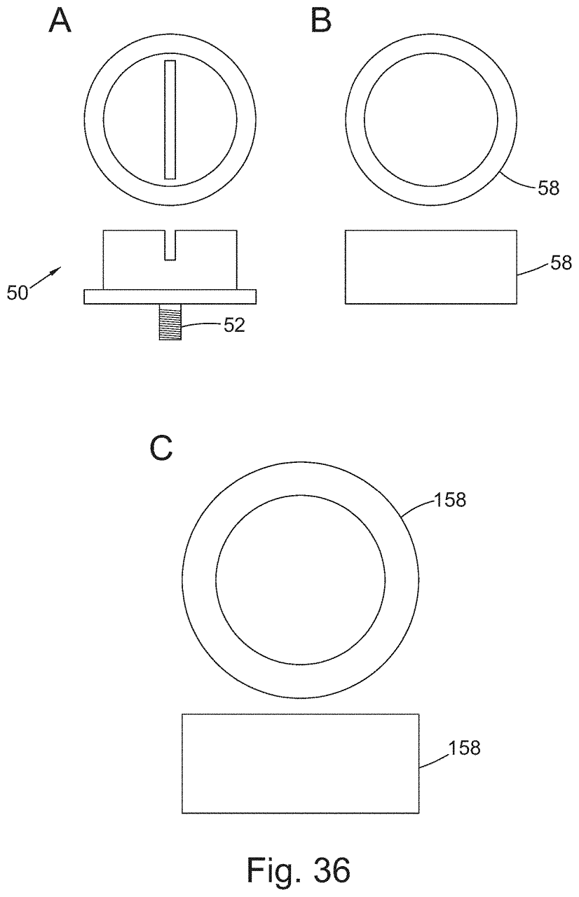

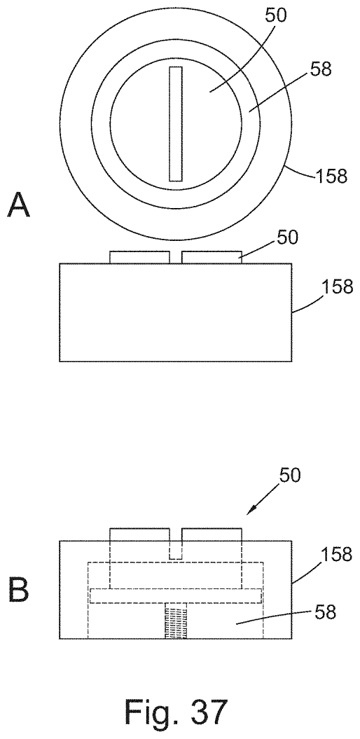

FIGS. 36 and 37 show an embodiment of a head 50 and collar, in an isolated and assembled form. The collar illustrated in FIGS. 36 and 37 comprises an inner collar 58 and outer collar 158. The inner collar 58 is flexible and is configured to seal and protect the head 50 as described above. The outer collar 158 is rigid and is configured to act as a frame to allow installation of the inner collar 58.

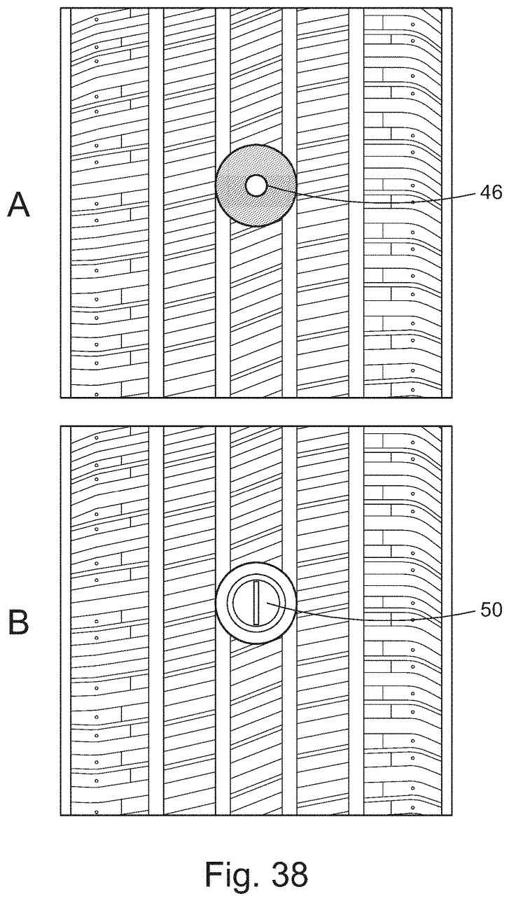

FIG. 38 shows a head 50 installed in a channel 46 of a tyre 24.

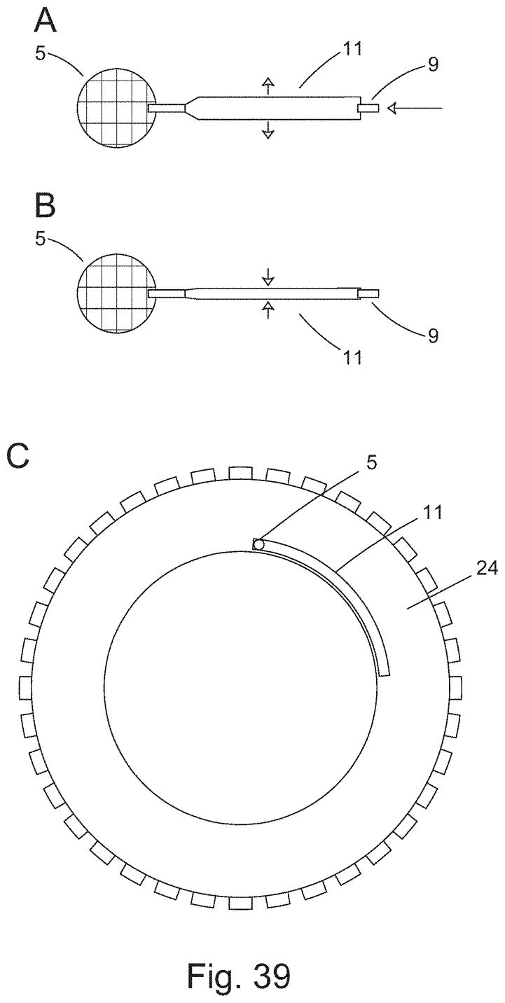

FIG. 39 shows a micro rim pump 11 which can be installed around the rim of a tyre, as illustrated. The micro rim pump 11 is configured to be compressed to expel air as the tyre rotates. The micro rim pump 11 may be operable to clean a filter and valve arrangement 5. The micro rim pump 11 may comprise a one-way valve 9 to allow air to flow into the micro rim pump 11 but not out of the micro rim pump 11. The micro rim pump 11 or other such mechanism may be installed in a tyre 24 in combination with any of the other pumps described herein and is included within this application by way of example of how the filter may be cleaned by auxiliary methods or means.

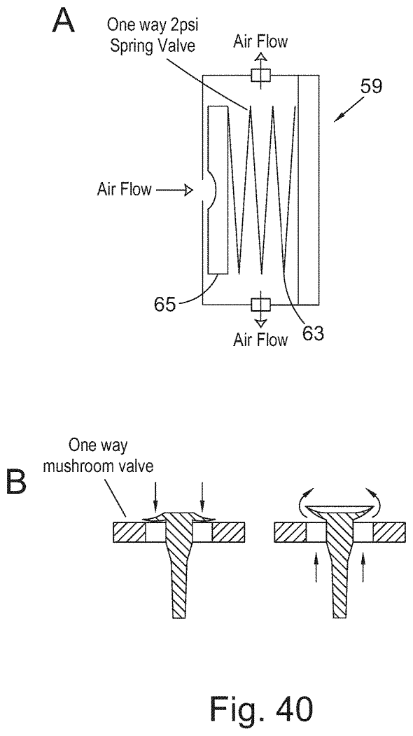

FIG. 40 shows an example spring-valve 59 and an example mushroom valve.

The spring-valve 59 comprises an internal spring 63 and closure 65 and is configured to prevent air flow in one direction. The spring-valve 59 is configured to permit air flow in the other direction (i.e. that which urges the closure 65 against the internal spring 63) once the pressure differential reaches a predetermined threshold. The valve may be suitable for use in any of the inlets, outlets or valves of the disclosed pump.

The spring-valve 59 may be arranged to establish a pressure drop across the valve of up to a certain value (depending on the stiffness of the spring). As such, integrating a spring-valve 59 as part of the port 34 may allow a user to configure the pump such that the pump only starts operating once a certain pressure differential is established between the housing cavity and the tyre cavity. This may configure the pump such that it only starts operating once a certain pressure-drop in the tyre cavity has been established—thus preventing the pump from overworking due to minor drops in pressure.

The mushroom valve is configured to permit air flow in only one direction and may be used in combination with the spring-valve 59 in order to achieve the above effect 67.

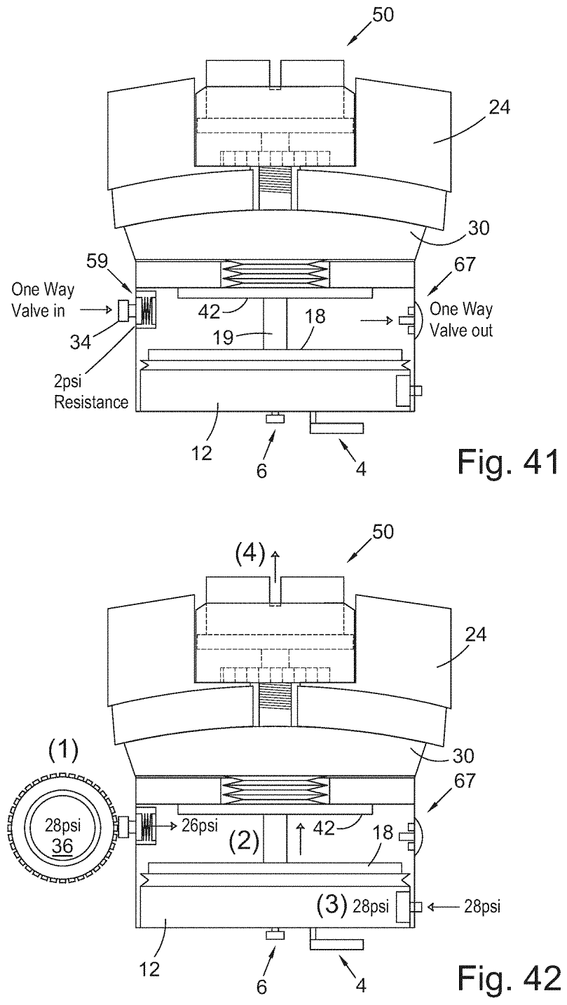

FIGS. 41 to 45 illustrate a pump including a spring-valve 59 and mushroom valve 67 and a tank valve 160. The arrangement of the spring-valve and mushroom valve 67 is such that the pump only starts operating to inflate the tyre once a specified pressure drop has been reached (in this case, approximately 2+ psi). This prevents overworking of the pump and can increase the operational lifetime of the pump.

The tank valve 160 illustrates a means by which the tank may be inflated directly; and in a different arrangement may permit and control a flow of fluid into the tank from the tyre to maintain tank pressure at a desired or pre determined pressure in relation to the tyre pressure.

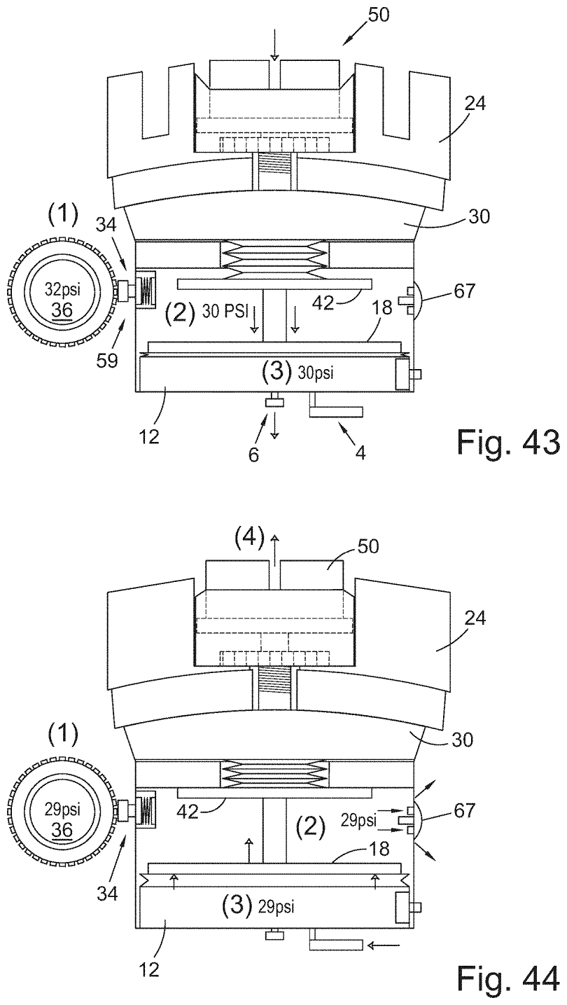

In FIG. 42 the tyre pressure is lower than the desired pressure and so the pump operates to inflate the tyre. The pump operates to inflate the tyre to the state shown in FIG. 43, where the tyre pressure is illustrated as 32 psi. Due to the use of the spring-valve 59, the pressure inside the housing cavity (and hence acting on the plate 18) is at kept at 2 psi lower than the tyre cavity pressure −30 psi. At this pressure, the pump (i.e. the return fluid tank 12) is configured to stop operating such that the tyre is not inflated over 32 psi.

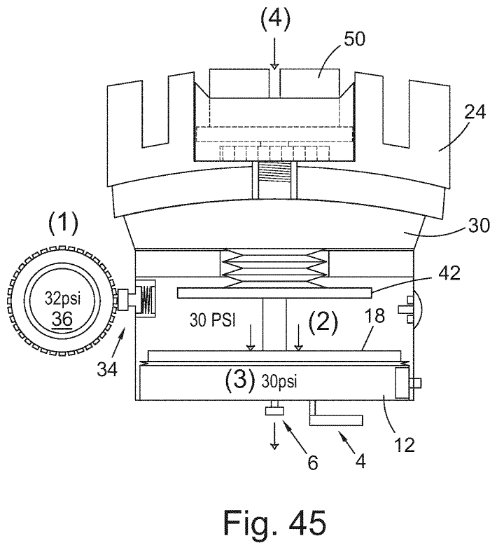

The tyre pressure then decreases over time. However, due to the use of the mushroom valve, the pressure in the housing cavity (i.e. that which acts on the plate 18) only starts to drop (and hence the pump only starts operating again), once the pressure in the tyre cavity drops below that of the housing cavity (which is illustrated as being 30 psi). Thus, the plate 18 is only moved back to the first position by the return fluid tank 12 and the pump only starts operating again once the pressure in the tyre has dropped by (in this example) 2 psi. FIG. 44 illustrates the tyre pressure (and hence housing cavity pressure) dropping to 29 psi, resulting in reactivation of the pump. FIG. 45 illustrates the end of the pumping cycle, by which time the tyre pressure is back to 32 psi, the housing cavity pressure is back to 30 psi and the pump stops operating.

It is noted that although the housing cavity is held at a different pressure to the tyre cavity, the tyre cavity is still in fluidic communication with the housing cavity in this example.

FIG. 46 shows a head insert 69. The head insert 69 is for insertion into a head casing 71 to form a head 150 for use in the pump. The head insert 69 comprises a contact surface 151 comprising a plurality of distinct layers 53. Each layer may have a different colour. As such, during use of the device, the colour of the head 150 changes as the contact surface of the head 150 wears. The outer surface of the head insert 69 comprises an external thread 73.

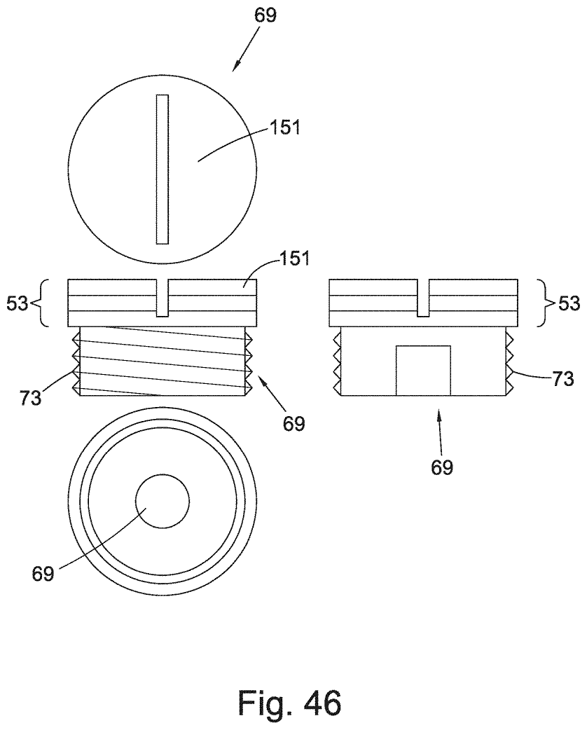

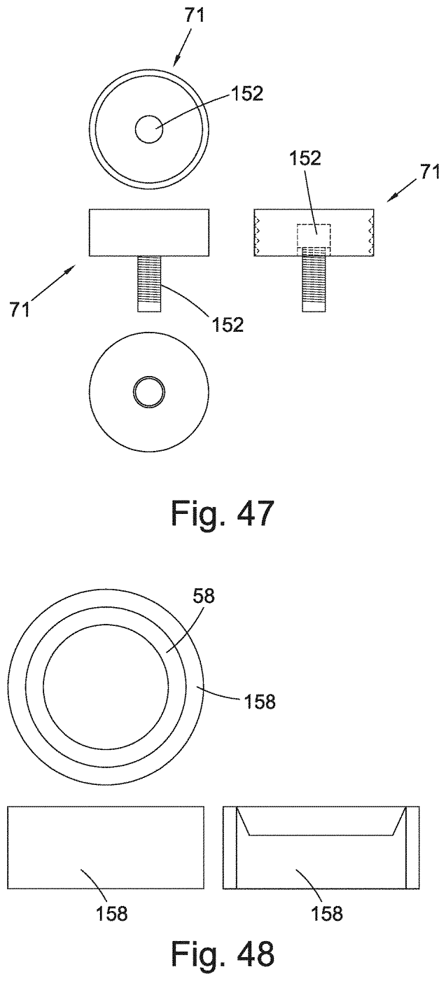

FIG. 47 shows a head casing 71. The head casing 71 comprises an upper section into which a head insert 69 can be screwed, and a lower section providing the screw thread 152 of the head 150.

FIG. 48 shows an example of a collar for use as part of the head 150 described with reference to FIGS. 46 and 47. The collar of this example is as described with reference to FIGS. 36 and 37 and comprises a flexible inner collar 58 and a rigid outer collar 158. This collar acts as a frame to allow installation of inner collar 58 and the head 150 into the tyre tread 28.

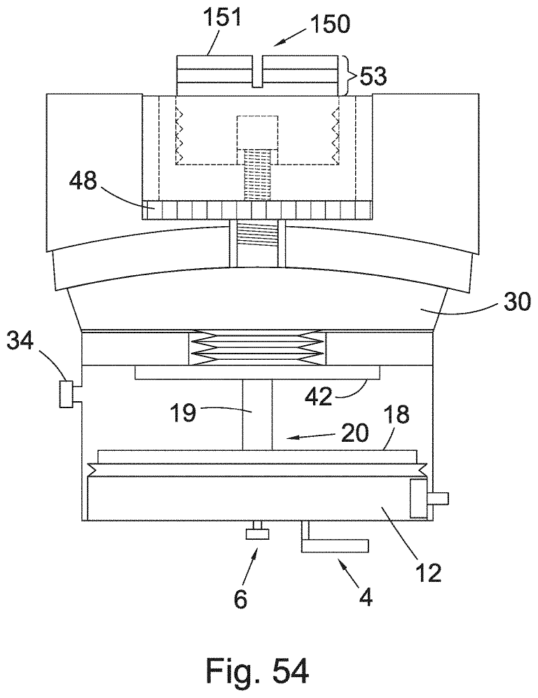

FIG. 49 illustrates the assembly of the head 150 described with respect to FIGS. 54 and 55, with the head insert 69 being screwed into the head casing 71. Such an embodiment allows the head insert 69 to be removed and replaced at will—thus avoiding the need to replace multiple parts due to wear.

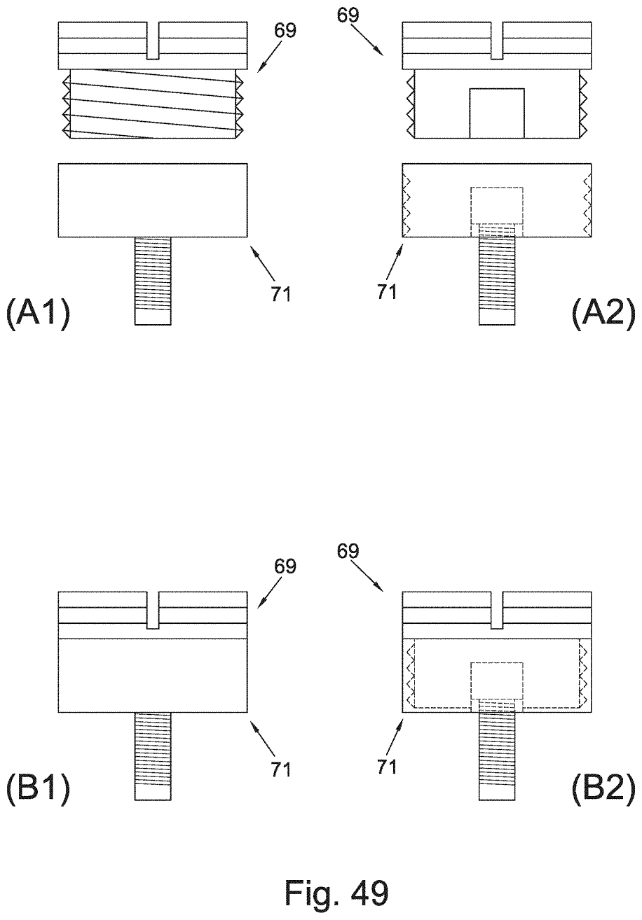

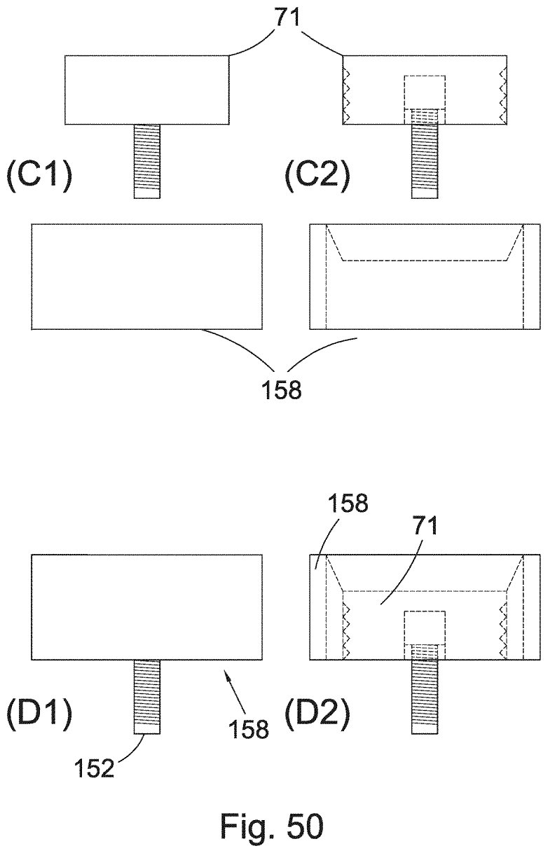

FIG. 50 illustrates the insertion of the head casing 71 into the collar 158 without first screwing the head insert 69 into the head casing 71.

FIG. 51 illustrates the combination of the collar and head casing 71 being assembled to the rest of the pump.

FIG. 52 illustrates the head insert 69 being screwed into the head casing 71.

FIGS. 53 and 54 illustrate the assembled pump with the actuation member 20 in the second and first positions, respectively.

The present invention has been described above purely by way of example. Modifications in detail may be made to the present invention within the scope of the claims as appended hereto. Furthermore, it will be understood that the invention is in no way to be limited to the combination of features shown in the examples described herein. Features disclosed in relation to one example can be combined with features disclosed in relation to a further example.

1. A pump for housing within a tyre, the pump comprising:
a fluid chamber comprising an inlet operatively connectable to the environment
and an outlet operatively connectable to a tyre cavity; wherein
the fluid chamber is compressible and is configurable to expel air into a tyre cavity via the outlet during compression of the fluid chamber and draw air in from the environment via the inlet during expansion of the fluid chamber;
an actuation member configurable to extend through the tread of a tyre for contacting a road surface during use;
the actuation member comprising a plate configured to compress the fluid chamber; wherein
the actuation member is configured to move between a first position, in which the fluid chamber is expanded, and a second position, in which the fluid chamber is compressed by the plate; and
the pump is configurable such that, in use, a part of the actuation member is in fluidic communication with the tyre cavity and fluid pressure contributes to a first force on the actuation member towards the second position;
the pump further comprising:
a return arranged to urge the actuation member towards the first position;
wherein the fluid chamber and/or return are configured to contribute to a second force acting on the actuation member towards the first position.

2. The pump of claim 1, wherein the return and actuation member are configured such that, in use, the first force is greater than or equal to the second force when the actuation member is in the second position and the pressure within the tyre cavity is at a predetermined level.

3. The pump of claim 1, wherein the pump is configured such that the force urging the actuation member towards the first position is greater than or equal to the force urging the actuation member towards the second position when the tyre is at a required, or predetermined, pressure.

4. The pump of claim 1, wherein the pump comprises a housing which defines a housing cavity, wherein the housing is configured such that the housing cavity is in fluidic communication with an environment surrounding the housing.

5. The pump of claim 4, wherein the plate is housed within the cavity and the plate is arranged such that a pressure of fluid within the cavity urges the plate towards the second position.

6. The pump of claim 1, wherein the return is configured to be in an expanded configuration when the actuation member is in the first position, and a compressed configuration when the actuation member is in the second position.

7. The pump of claim 6, wherein the return comprises a return fluid tank and the fluid within the return fluid tank is at, or above, the desired tyre pressure when the return is in the compressed configuration.

8. The pump of claim 7, wherein the return fluid tank comprises a one-way valve arranged to permit fluid flow into the return fluid tank for permitting fluid flow into the return fluid tank from a tyre cavity during use, but restricting fluid flow out of the return fluid tank.

9. The pump of claim 1, wherein the actuation member comprises a head arrangeable to extend from a tread surface of a tyre during use for contacting a road surface.

10. A tyre comprising a pump according to claim 1.

11. A tyre comprising a pump, wherein
the tyre defines a tyre cavity designed to operate at a predetermined tyre pressure;
the pump is arranged inside the tyre and comprises:
a fluid chamber comprising an inlet operatively connectable to the environment and an outlet operatively connectable to the tyre cavity; wherein
the fluid chamber is compressible and is configured to expel air into the tyre cavity via the outlet during compression of the fluid chamber and draw air in from the environment via the inlet during expansion of the compressible fluid chamber;
an actuation member configurable to extend through a tread of the tyre for contacting a road surface during use;
the actuation member comprising a plate configured to compress the fluid chamber; wherein
the actuation member is configured to move between a first position, in which the fluid chamber is expanded, and a second position, in which the fluid chamber is compressed by the plate; and
the pump is configured such that a part of the actuation member is in fluidic communication with the tyre cavity and fluid pressure contributes to a first force on the actuation member towards the second position;
the pump further comprising:
a return arranged to urge the actuation member towards the first position; wherein
the pump is configured such that the actuation member cycles between the first and second positions as the tyre rolls to inflate the tyre when the tyre is under the predetermined pressure.

12. The ˜tyre of claim 11, wherein the pump is configured such that the actuation member stays in the second position when the tyre is at or above the predetermined pressure.

13. The tyre of claim 11, wherein the pump is configured such that the force urging the actuation member towards the first position is less than or equal to the force urging the actuation member towards the second position when the tyre is at a required, or predetermined, pressure.

14. The tyre of claim 11, wherein the tyre defines a channel through the tread of the tyre and the actuation member extends through the channel such that, in use, the actuation member can contact a road surface.

15. The tyre of claim 11, wherein the actuation member comprises a head arranged within the tread of the tyre for contacting a road surface.

16. The tyre of claim 11, wherein the actuation member protrudes from the surface of the tyre tread when the actuation member is in the first position

17. The tyre of claim 11, wherein the actuation member is level with, or recessed with respect to, the tyre tread when the actuation member is in the second position.

18. The tyre of claim 11, wherein the pump comprises a sleeve comprising a thread; wherein the sleeve is housed within the channel in the tyre tread; the pump further comprising a locking nut configured to screwably engage the sleeve to assist in attaching the housing to the tyre.

19. A method for managing pressure within a tyre, the tyre comprising a pump; the pump comprising:
a fluid chamber comprising an inlet operatively connectable to the environment and an outlet operatively connectable to the tyre cavity; wherein
the fluid chamber is compressible and is configured to expel air into the tyre cavity via the outlet during compression of the fluid chamber and draw air in from the environment via the inlet during expansion of the compressible fluid chamber;
an actuation member configurable to extend through a tread of the tyre for contacting a road surface during use;
the actuation member comprising a plate configured to compress the fluid chamber; wherein
the actuation member is configured to move between a first position, in which the fluid chamber is expanded, and a second position, in which the fluid chamber is compressed by the plate; and
the pump is configured such that a part of the actuation member is in fluidic communication with the tyre cavity and fluid pressure contributes to a first force on the actuation member towards the second position;
the pump further comprising:
a return arranged to urge the actuation member towards the first position;
wherein the method comprises:
cycling the actuation member between the first and second positions as the tyre rolls to inflate the tyre when the tyre is under a predetermined pressure; and
maintaining the actuation member in the second position when the tyre is at or above the predetermined pressure.
